(19) United States
(12) Patent Application Publication
(10) Pub. No.: US 2022/0296939 A1
(43) Pub. Date: Sep. 22, 2022

(54) Head Covering Device Providing Filtered Intake and Exhaust Air

(71) Applicant: Hall Labs LLC, Provo, UT (US)

(72) Inventors: Michael Hall, Provo, UT (US); David R. Hall, Provo, UT (US); Chandler Flinders, Provo, UT (US); Jordan Englund, Provo, UT (US); Carson Richards, Spanish Fork, UT (US); Prabhakar Ramaraj, Provo, UT (US); Jacob Dean, Provo, UT (US); Vicente Oliveira, Orem, UT (US); Anthony E. Pullen, Tucson, AZ (US); Jeff Duncan, Tucson, AZ (US)

(73) Assignee: Hall Labs LLC, Provo, UT (US)

(21) Appl. No.: 17/209,158

(22) Filed: Mar. 22, 2021

(51) Int. Cl. A62B 18/04; A41D 13/11; A42B 1/04; A62B 7/10; A62B 23/02; A62B 18/08; A62B 9/00

(52) U.S. Cl. CPC A62B 18/045; A41D 13/1153; A41D 13/1184; A41D 13/1161; A42B 1/04; A62B 7/10; A62B 23/02; A62B 18/08; A62B 18/084; A62B 9/00

(57) ABSTRACT

A device for filtering air for a user comprising a rigid component comprising a transparent face shield that provides a space for air between an inside surface of the face shield and the user's face, an intake port, through which air enters the device, an exhaust port, through which air exits the device, a fabric component affixed to the rigid component that, combined with the rigid component, covers the user's head and seals around the user's neck, an intake filter that filters air passing through the intake port, an exhaust filter that filters air passing through the exhaust port, and an air mover held by the rigid component that moves air through the intake port and out the exhaust port.

### CROSS-REFERENCE TO RELATED APPLICATIONS

This application claims priority to U.S. Provisional Patent Application No. 62/992,277 titled “Head Covering Device” filed on Mar. 20, 2020, U.S. Provisional Patent Application No. 63/053,519 titled “Head Covering Device with Negative Air Flow”, U.S. Provisional Patent Application No. 63/053,523 titled “Head Covering Device with Environmental Control”, U.S. Provisional Patent Application No. 63/053,526 titled “Head Covering Device with a Communication Component”, U.S. Provisional Patent Application No. 63/053,537 titled “Head Covering Device with Automatic Air Moving System”, U.S. Provisional Patent Application No. 63/053,542 titled “Head Covering Device with Shroud”, U.S. Provisional Patent Application No. 63/053,546 titled “Head Covering Device with Washable Filtering Fabric”, U.S. Provisional Patent Application No. 63/053,548 titled “Head Covering Device with Electromagnetic Radiation Filtering Face Shield”, U.S. Provisional Patent Application No. 63/053,552 titled “Protective Mask with Negative Air Flow” filed on Jul. 17, 2020, and U.S. Provisional Patent Application No. 63/105,830 titled “Head Covering Device” filed on Oct. 26, 2020, which are incorporated herein by reference in their entirety.

### TECHNICAL FIELD

The present disclosure relates to head covering devices.

### BACKGROUND

Head covering devices (HCDs) on the market, such as helmets, are typically designed for some type of injury prevention. For example, personal protection equipment (PPE) for the head is commonly construction helmets or welder's helmets. Recreational protective head gear includes motorcycle helmets and sports helmets such as helmets for skiers, bikers, mountain climbers, baseball, and football players. Other types of HCDs include protection equipment such as splash shields and filters for firefighters, policemen, HAZMAT specialists, health care workers, and other first responders. In many cases, the HCDs are heavy, bulky and can be uncomfortable.

### SUMMARY

One aspect of the present invention is a device for filtering air for a user comprising a rigid component comprising a transparent face shield that provides a space for air between an inside surface of the face shield and the user's face, an intake port, through which air enters the device, an exhaust port, through which air exits the device, a fabric component affixed to the rigid component that, combined with the rigid component, covers the user's head and seals around the user's neck, an intake filter that filters air passing through the intake port, an exhaust filter that filters air passing through the exhaust port, and an air mover held by the rigid component that moves air through the intake port and out the exhaust port.

In another aspect of the invention, the rigid component further comprises an oval-shaped frame to which the transparent face shield is attached. The fabric component can be releasably attached by stretching around the frame. The fabric component may comprise an elastic band to facilitate stretching around the frame.

In a still further aspect, the fabric component further comprises a drawstring to facilitate forming a seal around the user's neck.

In a yet still further aspect, a portion of the fabric component comprises that does not cover the rigid frame is substantially impermeable to air. Another portion of the fabric component may cover the air mover, and wherein the other portion of the fabric component is permeable to air.

In another aspect, the fabric component has sufficient elasticity to allow a user to push against and outer surface of the fabric component to scratch or dab his face without breaking the seal around the neck.

In another aspect of the invention, the air mover is a fan assembly attached to the frame. The fan may be attached with a vibration absorbing mount to reduce noise and vibration in the device. The air mover may be powered by a rechargeable battery attached to an upper portion of the frame.

In still another aspect, the face shield is in the shape of a hemi-ellipsoid.

In a still further aspect, the air mover pulls intake air from outside of the device through the intake filter and into the device, whereby exhaust air is pushed through the exhaust filter to outside of the device.

In a still yet further aspect, the air mover pulls air from inside the device through the exhaust filter to outside of the device, whereby intake airs is pulled from outside of the device through the intake filter and into the device.

One aspect of the invention is a device for filtering air for a user comprising a rigid component comprising an oval-shaped frame, a transparent face shield that provides a space for air between an inside surface of the face shield and the user's face, a first and a second intake port, through which air enters the device, a first and a second exhaust port, through which air exits the device, a fabric component affixed to the rigid component that, combined with the rigid component, covers the user's head and seals around the user's neck, first and second intake filters that filter air passing through the intake ports, first and second exhaust filters that filter air passing through the exhaust ports, and a first and second air mover disposed over either the first and second intake ports, respectively, or the first and second exhaust ports, respectively, whereby filtered air is moved into the device through the intake ports and moved out of the device through the exhaust ports.

In another still yet further aspect, the first and second intake filters and the first and second exhaust filters are provided in filter cartridges. The filter cartridges may be releasably attached to an inner surface of the frame, to thereby facilitate replacement of the filter cartridges.

In another aspect of the invention, the first intake port is adjacent the first exhaust port, where the second intake port is adjacent the second exhaust port, wherein the first intake filter is combined in a single cartridge with the first exhaust filter, and wherein the second intake filter is combined in a single cartridge with the second exhaust filter.

In still another aspect, the combined surface areas of the intake and exhaust filters is greater than 200 inch².

In a still further aspect, the device further comprising an elastic band that connects to one side of the device, goes behind the head of the user inside of the fabric component, and connects to the other side of the device to better secure the device to the head of the user.

Further aspects and embodiments are provided in the following drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a front view of a user wearing a variable flow head covering device (VFHCD), according to an embodiment of the disclosure.

FIG. 2 is a side view of a user wearing a variable flow head covering device (VFHCD), according to an embodiment of the disclosure.

FIG. 3 is a rear view of a user wearing a variable flow head covering device (VFHCD), according to an embodiment of the disclosure.

FIG. 4 is an overhead view of a user wearing a variable flow head covering device (VFHCD), according to an embodiment of the disclosure.

FIG. 5 is a cross-sectional view of a user wearing a variable flow head covering device (VFHCD), according to an embodiment of the disclosure.

FIG. 6 is a perspective view of the variable flow head covering device (VFHCD) without the fabric and illustrating negative air flow, according to an embodiment of the disclosure.

FIG. 7 is a perspective view of the variable flow head covering device (VFHCD) without the fabric and illustrating positive air flow, according to an embodiment of the disclosure.

FIG. 8 is a perspective view of the variable flow head covering device (VFHCD) without the fabric and filter assemblies, according to an embodiment of the disclosure.

FIG. 9 is a bottom view of the underside of the variable flow head covering device (VFHCD) without the fabric and showing how the filter assemblies are attached, according to an embodiment of the disclosure.

FIG. 10 is a close-up view of a filter assembly, according to an embodiment of the disclosure.

FIG. 11 is a close-up view of the control box, according to an embodiment of the disclosure.

FIG. 12 is a view of the variable flow head covering device (VFHCD) being charged, according to an embodiment of the disclosure.

FIG. 13 is a view of a variable flow head covering device (VFHCD) with alternative fan locations, according to an embodiment of the disclosure.

FIG. 14 is a side view of a user wearing a variable flow head covering device (VFHCD) with an opened face shield, according to an embodiment of the disclosure.

FIG. 15 is a side view of a user wearing a variable flow head covering device (VFHCD) with a pocket, according to an embodiment of the disclosure.

FIG. 16 is a front view of a user wearing a variable flow head covering device (VFHCD) equipped with communication hardware components, according to an embodiment of the disclosure.

FIG. 17 is a cross-sectional view of a variable flow head covering device (VFHCD) 1850 equipped with an automatic air mover, according to an embodiment of the disclosure.

FIG. 18 is a side view of a user wearing a variable flow head covering device (VFHCD) equipped with a shroud, according to an embodiment of the disclosure.

FIG. 19 is a view of an empty variable flow head covering device (VFHCD) placed in a shroud, according to an embodiment of the disclosure.

FIG. 20 is a view of a closed shroud, according to an embodiment of the disclosure.

FIG. 21 is a view of a variable flow head covering device (VFHCD) in a shroud being carried by a user, according to an embodiment of the disclosure.

FIG. 22 is a view of a washable fabric component (WFC), according to an embodiment of the disclosure.

FIG. 23 is a view of a variable flow head covering device (VFHCD) with an electromagnetic radiation filtering face shield, according to an embodiment of the disclosure.

FIG. 24 is a view of a variable flow head covering device (VFHCD) with a patternable electromagnetic radiation filtering face shield, according to an embodiment of the disclosure.

FIG. 25 is a front view of a variable flow head covering device (VFHCD) integrated with an impact resistant top portion, according to an embodiment of the disclosure.

FIG. 26 is a side view of a variable flow head covering device (VFHCD) integrated with an impact resistant top portion, according to an embodiment of the disclosure.

FIG. 27 is a view of user with a variable flow head covering device (VFHCD) that is controlled and monitored by an app on a smart device, according to an embodiment of the disclosure.

FIG. 28 shows a graphical user interface for monitoring and controlling functions of a variable flow head covering device (VFHCD) with an app, according to an embodiment of the disclosure.

FIG. 29 shows a graphical user interface for monitoring and controlling functions of a variable flow head covering device (VFHCD), according to an embodiment of the disclosure.

FIG. 30 shows a graphical user interface for monitoring biometric information in a variable flow head covering device (VFHCD), according to an embodiment of the disclosure.

FIG. 31 illustrates how an active band is to be installed in a variable flow head covering device (VFHCD), according to an embodiment of the disclosure.

FIG. 32 is a view of a variable flow head covering device (VFHCD) with an active band installed, according to an embodiment of the disclosure.

FIG. 33 is a front view of a vibration isolating air moving device (VIAMD), according to an embodiment of the disclosure.

FIG. 34 is a rear view of a vibration isolating air moving device (VIAMD), according to an embodiment of the disclosure.

FIG. 35 is a side view of a vibration isolating air moving device (VIAMD), according to an embodiment of the disclosure.

FIG. 36 is a side view of a vibration isolating air moving device (VIAMD) showing the fan outlet and air flow, according to an embodiment of the disclosure.

FIG. 37 is an example of combining a PAPR mask with a vibration isolating air moving device (VIAMD), according to an embodiment of the disclosure.

### DETAILED DESCRIPTION

### Overview

Embodiments of methods, materials and processes described herein are directed towards head covering devices. Head covering devices, also referred to as personal protection headwear, can be used to provide a filtered air environment to a user to prevent a user from being infected with a contagious disease. Head covering devices may also filter the exhaust air to prevent a user from spreading a contagious disease.

Head covering devices disclosed herein include a rigid component and a flexible component combined to completely cover the head of a user. The rigid component includes a frame and a transparent face shield. The flexible component includes a fabric that seals around the neck of a user. The disclosure herein describes various designs and components including air movers and air filters to filter the air entering the device and the air being exhausted from the device.

### Definitions

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “user” refers to any individual who uses an HCD.

As used herein, the term “filter,” as a noun, refers to a device, typically composed of fibrous or porous materials which removes unwanted components, usually in the form of particulates, such as dust, pollen, mold, viruses, and bacteria, from air. Filters containing an adsorbent or catalyst, such as charcoal (carbon), may also remove odors and gaseous pollutants such as volatile organic compounds or ozone. Air filters are generally used in applications where air quality is important. As a verb, “filter” refers to the act of removing particles from air.

As used herein, the term “transparent” is used in its normal sense, that is the property of allowing light to pass through so that behind can be distinctly seen therethrough. The transparent components described and defined below are preferably clear, but may be tinted, in whole or in part.

The term “negative air flow” is used to indicate that, in accordance with embodiments of the invention, air is actively pulled inside the HCD through an intake filter by an air mover and the air is exhausted out an exhaust filter.

The term “positive air flow” is used to indicate that, in accordance with embodiments of the invention, air is actively pulled inside the HCD by an air mover through an intake filter in the air mover and exhausted through an exhaust filter.

The term “neutral air flow” is used to indicate that, in accordance with embodiments of the invention, a substantially static flow of air is maintained in the HCD. The air flow into and out of the HCD is controlled by the breathing in and breathing out of the user.

As used herein, the term “thermoelectric cooler” refers to cooling devices that operate on the principle of the Peltier effect. A thermoelectric cooler may also be used for temperature control for both heating and cooling depending upon how it is arranged in a device.

As used herein, the term “Peltier effect” refers to the effect that creates a temperature difference by transferring heat between two electrical junctions. A voltage is applied across joined conductors to create an electric current. When the current flows through the junctions of the two conductors, heat is removed at one junction and cooling occurs. Heat is deposited at the other junction. The main application of the Peltier effect is cooling, though the Peltier effect can also be used for heating or control of temperature.

As used herein, the terms “energy recovery device” and “heat recovery device” refers to a device that operates on the basis of air-to-air exchange theory where two air-streams in contact and passing in opposite directions transfers heat/energy between the two air-streams.

As used herein, the term “phase-change material” or “PCM” refers to materials that use the heat of crystallization, melting or some other phase change to thereby either store heat in a predetermined temperature range or release heat in a predetermined lower temperature range.

As used herein, the term “polarizer” is an optical filter that lets light waves of a specific polarization pass through while blocking light waves of other polarizations. A polarizer can filter a beam of light of undefined or mixed polarization into a beam of well-defined polarization, that is polarized light.

As used herein, the term “photochromic” refers to a device or system where the optical properties change on exposure to light having a predetermined property, most commonly ultraviolet (UV) radiation. Most commonly, an optical lens changes from an optically transparent state to a darkened state upon exposure to UV radiation. When the UV radiation is removed, the lens returns to a clear state.

As used herein, the term “electrochromic” is where optical properties such as optical transmission, absorption, reflectance and/or emittance can be controlled in a reversible manner upon, application of an electrical energy, such as a voltage bias.

As used herein, the term “optical head-mounted display” (OHMD) refers to a wearable device that has the capability of reflecting projected images as well as allowing the user to see through the display, similar to augmented reality technology.

As used herein, the term “augmented reality” (AR) refers an interactive experience of a real-world environment where the objects that reside in the real world are enhanced by computer-generated perceptual information, sometimes across multiple sensory modalities, including visual, auditory, haptic, somatosensory and olfactory. AR can be defined as a system that fulfills three basic features: a combination of real and virtual worlds, real-time interaction, and accurate 3D registration of virtual and real objects.

As used herein, the term “hook-and-loop fastener” which is commonly referred to as “Velcro” refers to two components: typically, two lineal fabric strips (or, alternatively, round “dots” or squares) which are attached (sewn or otherwise adhered) to the opposing surfaces to be fastened. The first component features tiny hooks, the second features smaller loops. When the two are pressed together the hooks catch in the loops and the two pieces fasten or bind temporarily. When separated, by pulling or peeling the two surfaces apart, the strips make a distinctive “ripping” sound.

As used herein, the term “proximity sensor” refers to a sensor that is able to detect the presence of nearby objects without any physical contact. A proximity sensor often emits an electromagnetic field or a beam of electromagnetic radiation (infrared, for instance), and looks for changes in the field or return signal. The object being sensed is often referred to as the proximity sensor's target. Different proximity sensor targets demand different sensors. For example, a capacitive proximity sensor or photoelectric sensor might be suitable for a plastic target; an inductive proximity sensor always requires a metal target. Other types of proximity sensors include capacitive displacement sensor, Doppler effect sensor, magnetic sensor, reflective sensor, photoelectric sensor, laser rangefinder sensor, thermal infrared sensor, radar sensor, ionizing radiation sensor, ultrasonic sensor, fiber optics sensor, or a Hall effect sensor.

As used herein, the term “QR (quick response) code” refers to a type of matrix barcode (or two-dimensional barcode) first designed in 1994 for the automotive industry in Japan. A barcode is a machine-readable optical label that contains information about the item to which it is attached. In practice, QR codes often contain data for a locator, identifier, or tracker that points to a website or application. A QR code uses four standardized encoding modes (numeric, alphanumeric, byte/binary, and kanji) to store data efficiently; extensions may also be used. A QR code consists of black squares arranged in a square grid on a white background, which can be read by an imaging device such as a camera and processed using Reed—Solomon error correction until the image can be appropriately interpreted. The required data is then extracted from patterns that are present in both horizontal and vertical components of the image.

As used herein, the term “occupational noise” refers to the amount of acoustic energy received by an employee's auditory system when they are working in the industry. Occupational noise, or industrial noise, is often a term used in occupational safety and health, as sustained exposure can cause permanent hearing damage. Occupational noise is considered an occupational hazard traditionally linked to loud industries such as ship-building, mining, railroad work, welding, and construction, but can be present in any workplace where hazardous noise is present.

As used herein, the term “noise cancelling” refers to earpieces or headphones that utilize active noise control (ANC), which is also known as noise cancellation (NC), to reduce unwanted noises and sound by the addition of a second sound specifically designed to cancel the first.

As used herein, the term “night vision device” which is also known as “night vision goggles”, refers to an optoelectronic device that allows images to be produced in levels of light approaching total darkness. The image may be a conversion to visible light of both visible light and near-infrared, while by convention detection of thermal infrared is denoted thermal imaging.

### Exemplary Embodiments

The present disclosure relates to HCDs to provide a controlled and comfortable environment to a user. Users may need a controlled environment due to various health-related reasons such as to protect those with respiratory ailments, compromised immune systems, advanced age, from airborne contagion. The same protection may also be needed for the protection of health care providers. Alternatively, such devices may be desirable to use in harsh environments, such as extreme cold or heat, or environments with high levels of suspended particulate, such as dust. Still further, such devices may also be desirable to protect the user from harsh noise environments. The present disclosure illustrates embodiments of HCDs that include an air mover.

In various exemplary embodiments, the HCD includes a rigid component and fabric component that when combined, completely cover the head of a user and seals around the neck of the user. In various exemplary embodiments, the fabric component comprises a portion that is permeable to air and a portion that is impermeable to air. An air mover can pull air from inside the HCD and exhausts it to the environment, pull air from outside the HCD to inside the HCD and exhaust it to the environment, or maintain a neutral air flow as desired by a user. The air that passes through an inlet port to enter the HCD is filtered and an outlet port to exhaust air is also filtered.

In various exemplary embodiments, the HCD further comprises environmental and climate control components to monitor and control the air inside the HCD and to dim the face shield. The HCD may further comprise communication components to communicate with other users. The HCD disclosed herein may further include vibration isolating air movers to reduce noise inside the HCD.

### Variable Flow Head Covering Device (VFHCD)

The following embodiments relate to a variable flow head covering device (VFHCD) capable of negative, positive, or neutral air flow to provide a comfortable and controlled environment for a user.

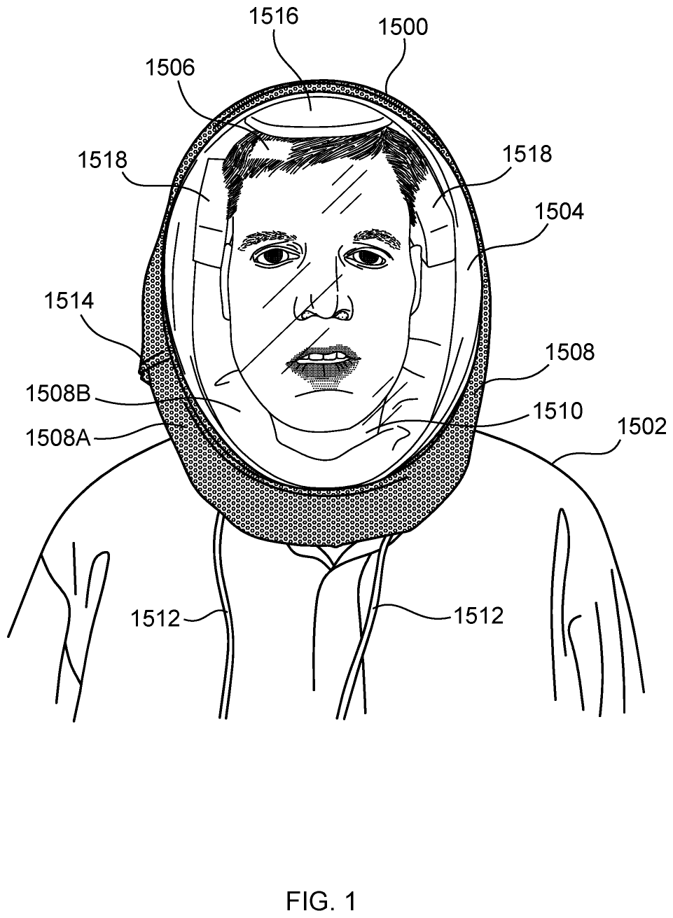

FIG. 1 is a front view of a user wearing a variable flow head covering device (VFHCD) 1500, according to an embodiment of the disclosure. A VFHCD 1500 is placed over the head of a user 1502. The VFHCD comprises a rigid frame 1504 and a rigid transparent face shield 1506. Frame 1504 may be constructed from a rigid or semi-rigid material. Frame 1504 is a hoop-like structure wherein the perimeter of the frame has a generally oval shape but may also be generally circular or some other appropriate shape, such as pear-shaped. Frame 1504 comprises a channel 1508. The edge of the face shield 1506 may be placed in and sit in the channel.

Frame 1504 may be constructed from a rigid polymer or metal or a combination thereof. The polymer may comprise fiberglass, carbon fiber, graphene, polyamide, polycarbonate (PC), polyester, high density or low density polyethylene, polyethylene terephthalate (PET), polypropylene (PP), polystyrene (PS), polyurethane, polyvinyl chloride (PVC), polyvinylidene chloride, acrylonitrile butadiene styrene (ABS), polymethylmethacrylate (PMMA), polytetrafluorethylene (PTFE), phenolic, polyetheretherketone (PEEK), maleimide, bismaleimide, polyetherimide, polyimide, plastarch, furan, silicone, polysulfone, rubber, or a combination thereof. The frame may have a generally oval shape and circles a user's head, with a lower half passing below the user's chin and an upper half passing above a user's forehead.

The face shield 1506 is shaped as a hemi-ellipsoid and is preferably set close enough to the face of a user where the user's eyes are unable to focus on the inner surface of the face shield, and thus not interfere with the vision of the user. The face shield may be permanently attached to the frame 1504 or may be detachable from frame. If permanently attached, this may be accomplished by using an adhesive, thermal welding, or some other means. If detachable, the face shield may be held securely to the frame using an attaching device, such as a hook and loop fastener (Velcro®), clamps, clasps, magnets, screws, or other means.

The face shield may have a thickness in the range of about 0.05-0.25 inches. In the depicted embodiment, the face shield 108 has a thickness of about 0.125 inches. The face shield may be constructed from materials that are approved for impact resistance by the American National Standards Institute (ANSI). The face shield may be double-walled, preferably with a vacuum therebetween, for extra insulation. The face shield may comprise a scratch resistant coating or layer on the inner and/or outer surface to prevent abrasions or other damage. The face shield may comprise an anti-fogging coating on the inner or outer surface. A replaceable protective layer may be placed over the outer surface of the face shield. Naturally, the replaceable protective layer should comprise a transparent polymer.

A top portion of the transparent face shield may extend above a user's eyes, a bottom portion extends below the user's mouth and a first and second side portion extend beyond the user's side peripheral vision. The top portion of face shield may extend above a user's forehead and the bottom portion extends below the user's chin.

In a preferred embodiment, face shield 1506 is a rigid transparent polymer or glass. The polymer may comprise an acrylic such as polymethylmethacrylate. The polymer may comprise polystyrene (PS), polycarbonate, glycol modified polyethylene terephthalate (PETG), or cellulose acetate butyrate or a combination thereof. In some embodiments, the face shield is made from a laminate of polymeric films, each contributing to the structural or optical properties of the face shield. As an example, one layer of the laminate may be included to provide shatter resistance.

In some embodiments, the face shield further comprises an area in the line of sight for a user that provides eye correction and improved vision. The VFHCD may be able to project images on the internal surface of the face shield. For example, the VFHCD may be capable of AR fora user.

In other embodiments, the transparent face shield further comprises a mechanical wiper and motor to clear debris from the front surface of the face shield. In still other embodiments, the transparent face shield further comprises a vibrator to vibrate the face shield to clear debris from the front surface of the face shield. The vibrator may be an ultrasonic vibrator or a pneumatic hammer.

FIG. 1 also illustrates a view of a fabric component 1508. The fabric component may also be referred to as a neck skirt, neck seal, neck collar, or neck shroud. The fabric preferably fits snugly around the neck 1510 of a user 1502, such that particulates do not able to pass between the fabric and the neck of the user. The fabric may be flexible or stretchable and may be made of a polymer such as polyester, polypropylene, polytetrafluorethylne (PTFE), polyether ether ketone (PEEK), polyethene-co-chlorotrifluoroethene (E-CTFE), silicone, rayon, spandex, Lycra®, viscose, stretched polytetrafluoroethylene (PTFE), or nylon. The fabric may be made of a natural fabric such as cotton or wool, a composite of a natural fabric and a polymer, or a pharmaceutical grade textile.

As depicted, the fabric component 1508 is comprised of a single sheet of fabric. The single sheet of fabric, together with the transparent face shield and the frame, cover a user's entire head and a lower portion of the single sheet of fabric encircles the user's neck and forms a seal therewith. The fabric component comprises a drawstring 1512 to tighten around the neck of a user for better sealing properties. In some embodiments, it is preferred to include buttons on the drawstrings to hold the drawstrings in the tightened position. The drawstring is to facilitate the fabric component forming a seal around the user's neck. Alternatively, the single sheet of fabric may possess enough stretch to allow the device to be placed over the user's head while leaving the lower portion of the single sheet of fabric intact and still capable of forming a seal around the user's neck.

The fabric component shown in FIG. 1 comprises a portion 1508A that is permeable or porous to air and a portion 1508B that is impermeable to air. The impermeable portion may be substantially air-tight and does not cover the frame. The air permeable portion is stretched around the frame 1504, covers the air movers, and allows air to pass through. The fabric component can be releasably attached by stretching around the frame. The fabric component may comprise an elastic band to facilitate stretching around the frame. The air impermeable portion 1508B seals around the neck of a user. The air impermeable portion may be baggy and stretchable to allow a user to stretch the fabric with their hand to dab or scratch their face without breaking the seal around the use's neck. The air permeable and air impermeable portions may comprise materials of the same composition or different compositions. The air permeable and air impermeable portions may be joined by a seam. The fabric component may be removable and washable.

The fabric component 1508 may comprise two or more layers. For example, the air impermeable portion may comprise an inner softer second sheet of fabric located between the air impermeable portion and the skin of the user. The inner sheet may be soft, washable and absorbent.

The fabric component further comprises an access 1514. The access allows a user to access the controls to the device located on the frame underneath the fabric. The access may be a flap that can be opened and closed and secured shut with a zipper, hook and loop fastener, button, or other method. The access may be located anywhere on the fabric on the periphery of the frame.

In some embodiments, the fabric component or portion may comprise a small foam block or insert that a user can use to scratch their noses without having to remove the VFHCD. The foam block or insert may be mounted on the face shield or on the frame. In other embodiments, the fabric component comprises finger sockets that protrude into the facial area of the VFHCD. Finger sockets allow a user to insert their fingers without compromising the environment inside the VFHCD but yet allow the user to scratch or rub an itch. The fabric component may be baggy and stretchable enough for a user to scratch their nose or dab their face without breaking the seal around the user's neck.

As shown in FIG. 1, the VFHCD 1500 rests on top of the head of the user. A resting pad 1516 is placed at the top of the face shield 1506 that provides support and cushion between the device and the head of the user. The resting pad may comprise a cushion-like material such as cloth, foam, rubber, or other soft material and may be replaceable and washable. Multiple materials, sizes and/or shapes of removable resting pads may be available, so that the user can select the most comfortable one for their size and shape of head.

Also shown in the VFHCD in FIG. 1 are earpieces 1518 to reduce noise, and dampen sound, and reverberations inside of the device as previously described herein. In a preferred embodiment, the earpieces are placed in front of the ears. As with the resting pad, multiple materials, sizes and/or shapes may be available and adaptable to provide comfort to the user depending on the shape and size of their head.

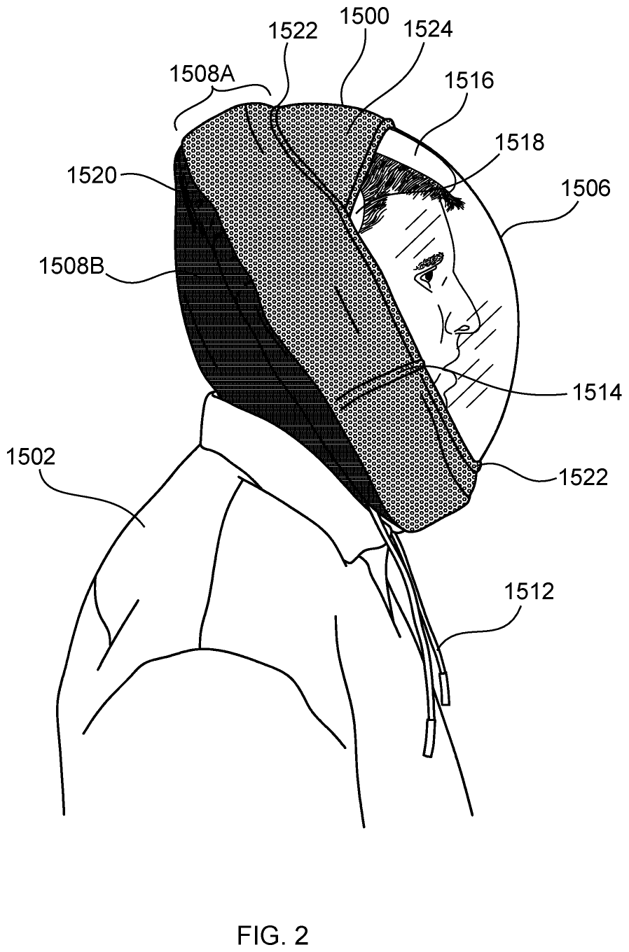

FIG. 2 is a side view of a user wearing a variable flow head covering device (VFHCD) 1500, according to an embodiment of the disclosure. This view further illustrates how the fabric component 1508 is composed of an air permeable portion 1508A and an air impermeable portion 1508B. The fabric component further comprises a first seam 1520 that connects the air permeable portion to the air impermeable portion. The fabric component further comprises a second seam 1522 that connects the air permeable portion 1508A to a top portion 1524 of the fabric. The seams may comprise an elastic material to hold the fabric securely onto the frame. The top portion of the fabric 1524 also aids in preventing the fabric from slipping off the frame. The top portion may be permeable or non-permeable. The first seam 1520 helps to form a seal around the bottom of the frame to prevent air in the neck from escaping that does not pass through a filter.

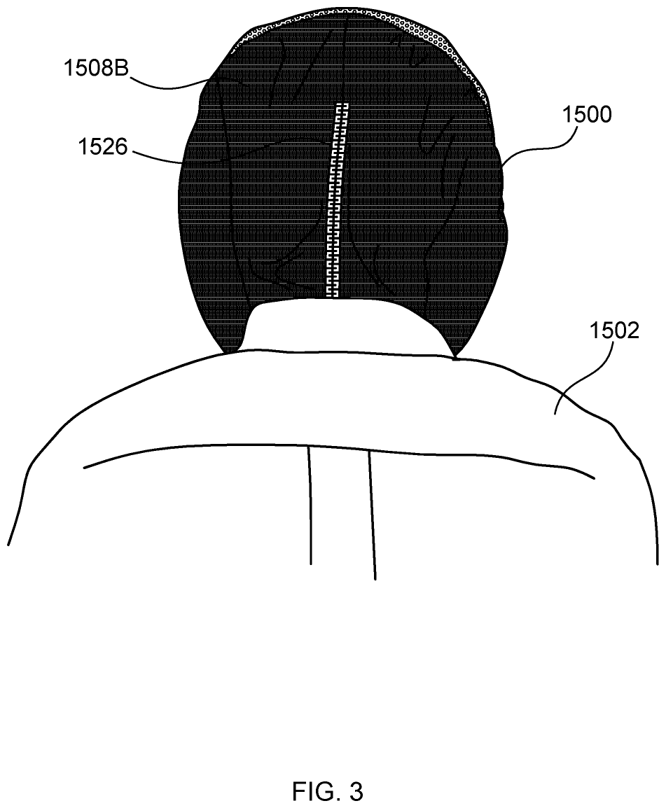

FIG. 3 is a rear view of a user wearing a variable flow head covering device (VFHCD) 1500, according to an embodiment of the disclosure. This view illustrates how the device may be designed so that it can opened and closed without messing up the hair or makeup of a user. This embodiment comprises a zipper 1526. When the zipper is unzipped, allows the device to be fit over the user's head, and when zipped facilitates the fabric component forming a seal around the user's neck. Other embodiments may comprise an ultra-stretchable fabric that can be opened widely enough to not mess up the hair or makeup of a user.

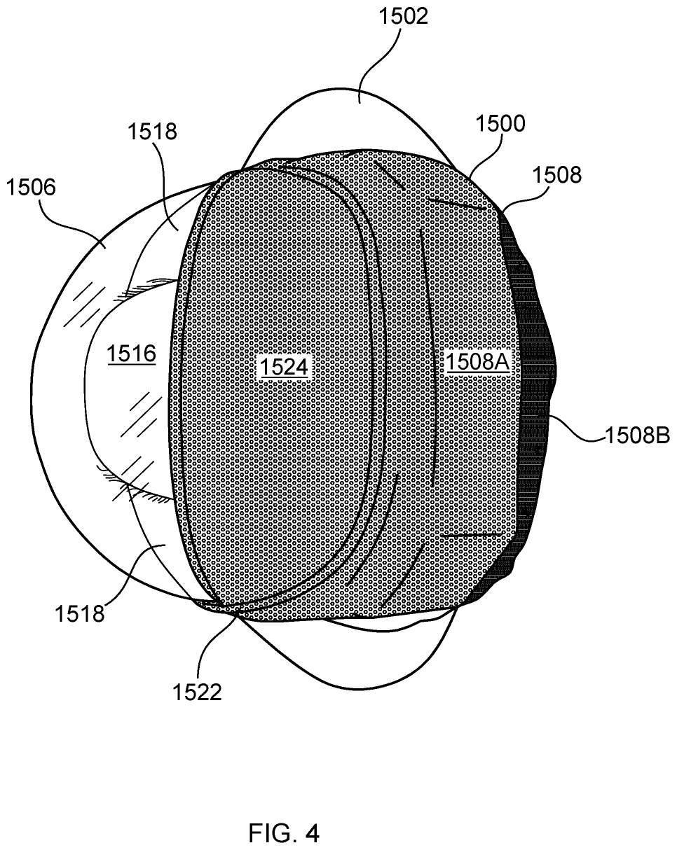

FIG. 4 is an overhead view of a user wearing a variable flow head covering device (VFHCD) 1500, according to an embodiment of the disclosure. This view further illustrates how the fabric component 1508 is secured over the frame. The top portion 1524 of the fabric extends over the face shield 1506. The resting pad 1516 extends over the top of the head of the user 1502.

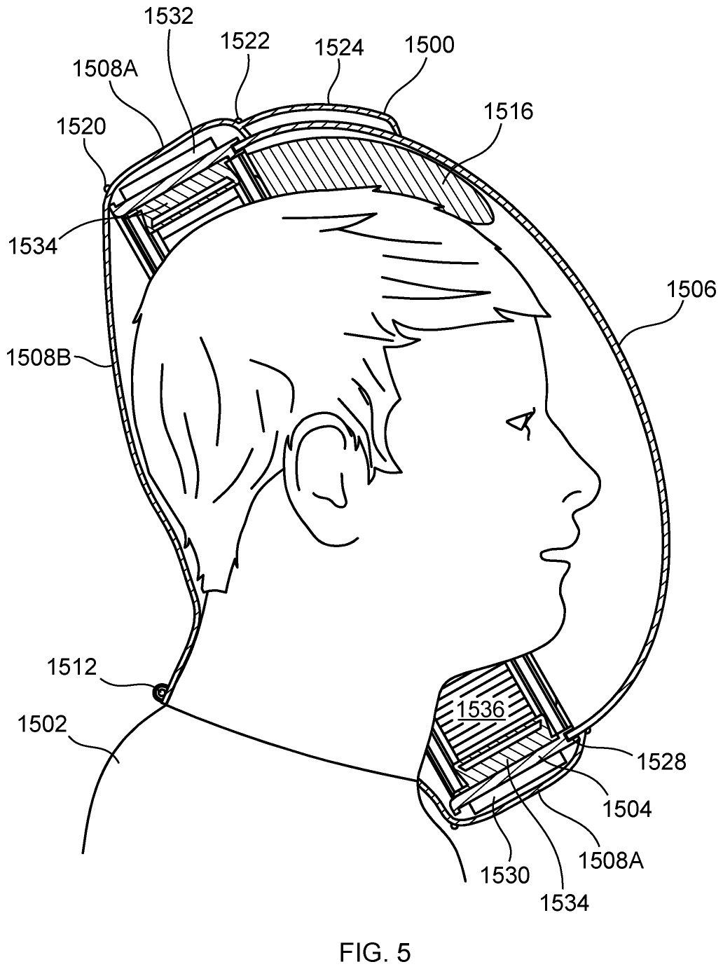

FIG. 5 is a cross-sectional view of a user wearing a variable flow head covering device (VFHCD) 1500, according to an embodiment of the disclosure. This view better illustrates the frame and other components of the VFHCD. The face shield sits in a channel 1528 in the frame 1504. The channel runs along the top edge of the frame. The face shield may be reversibly removed from or placed in the channel.

Mounted to the frame is an air mover 1530. The air mover may be a fan or other air moving device as previously described herein. In this embodiment, the air mover may be located near the mouth of a user or may be mounted at any other location on the frame. The frame may comprise one or more air moving devices. The air mover moves air into or out of a port in the frame. The air mover is powered by one or more batteries in a battery pack 1532 that is also mounted to the frame. The battery pack may be mounted at any location on the frame, such as the upper portion of the frame.

The VFHCD further comprises a filter assembly 1534 located on the inside of the frame. In other embodiments, the filter assembly may be located on the outside of the frame. The filter assembly further comprises a filter 1536. The filter assembly can be connected to the frame by hook-and-loop fasteners, clips, snaps, channels, or other mechanism. In a preferred embodiment, the filter assembly can be reversibly removed or attached to the frame. The VFHCD may comprise two or more filter assemblies. The filter is to filter incoming air or outgoing air from inside the device.

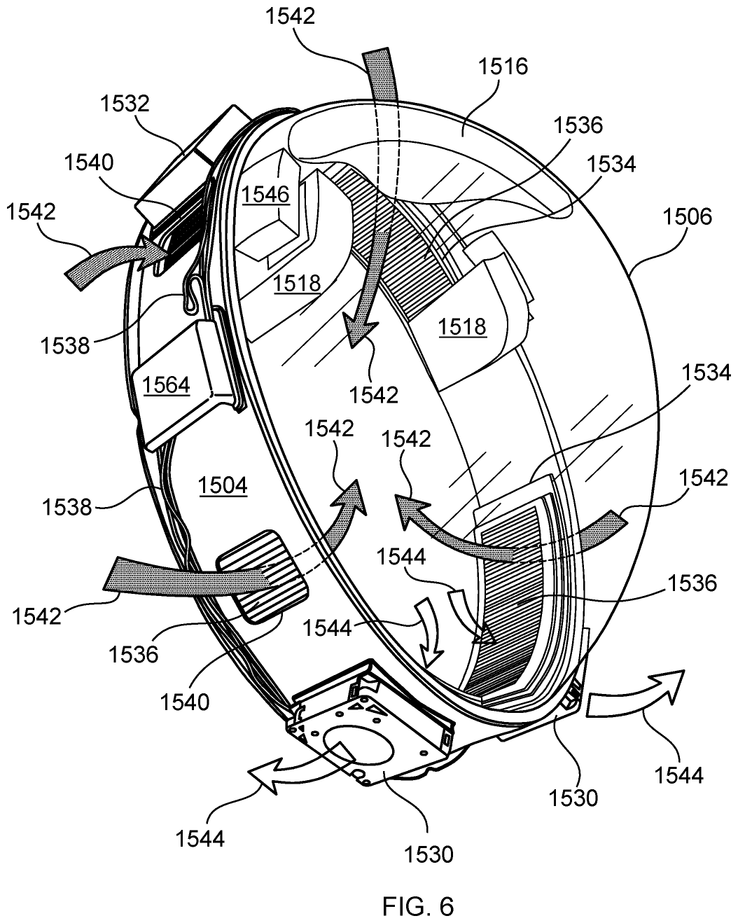

FIG. 6 is a perspective view of the variable flow head covering device (VFHCD) 1500 without the fabric and illustrating negative air flow, according to an embodiment of the disclosure. This view further illustrates the components of the VFHCD that are typically hidden from view when the fabric component is stretched over the frame 1504. The fans 1530 and battery pack 1532 are mounted to the outer surface of the frame and are in electronic communication with the control box 1564 via electrical wiring 1538. The control box comprises an on/off air mover switch, charge port, and LED (light emitting diode) indicator lights. The control box may comprise other controls to operate components of the VFHCD such as lights, sensors, or air mover speeds.

FIG. 6 further illustrates a port 1540 in the frame. The port may be an air inlet or air outlet port. There may be one or more ports. Air may move into or out of the ports depending on how the air movers 1530 are designed. An air mover may be placed over one, two, three, four, five or all six of the ports in the frame to assist the movement of both inlet and exhaust air. Some air movers may pull air into the device and some air movers push air out of the device. For example, two air movers may pull air out of the device while another two air movers may push air into the device. In another embodiment, two air movers may pull air out of the device while another four air movers my push air into the device. Other combinations of air movers may be used to pull air into the device and push air out of the device.

As illustrated in FIG. 6, air movers, such as fans, can pull air from inside the VFHCD device through the fans to outside of the device forming a negative air flow. This is illustrated by arrows 1544 that pass through a filter 1536 in a filter assembly 1534. The air that enters the device passes through a filter 1536 located in an intake port 1540 (also referred to herein as an inlet port and used interchangeably). Air that is in the device and exhaust air from a user may be exhausted through a filter and out an air mover 1530. This exhaust air is represented by arrows 1544. Each fan is situated directly over a port. There are twice as many additional ports as ports that are situated over the fans. As illustrated in FIG. 6, there are two fans attached to the frame and each fan is located over a port. There are an additional four more ports 1540 to allow for unrestricted air flow that are not located over a fan. Only two are in view in FIG. 6 as the other two are hidden by the filter assemblies. Two fans pull air out of the device through to exhaust ports and filters, while air enters the device through four intake ports and intake filters.

In some embodiments, the air movers may comprise a pressure sensor and a processor receiving input from the pressure sensor. The pressure sensor and processor can be adapted to increase or decrease power to the air mover to thereby regulate the pressure inside the head covering device. In some instances, the user may desire to have neutral air flow in addition to negative or positive air flow. The sensor and processor may be used to control and regulate the desired air flow.

In some embodiments, the inlet port or exhaust port further comprises filter covers to reduce noise entering or exiting the VFHCD 1500. In some embodiments, the fans may be attached with a resilient mount to the frame to reduce noise and vibration.

The filters 1536 located over the air inlet and outlet ports are pleated. This increases the surface are of the filter to increase filtering efficiency and to prevent air flow from being restricted. The surface area of the filters in the device may be greater than 50 inch². In other embodiments, the surface area of the filters in the device may be greater than 100 inch². In a preferred embodiment, the surface area of the filters in the device may be greater than 200 inch². In other embodiments, the filters may not be pleated.

The inlet filter is adapted to block the passage of a virus, bacteria, smog, noxious gas, poisonous gas, smoke, or a combination thereof, to purify the incoming air for a user. The outlet filter may also filter the exhaust air. This is beneficial if a user has an infectious disease which would prevent non-wearers of the VFHCD from being infected. This device could be used in a hospital, nursing home, or other facility by an infected nurse, doctor, or other health care worker without the risk of infecting the patients that they are treating that may have compromised immune systems. The filters can be readily changed depending on the environment where the device is being used. In a preferred embodiment, the filter is a HEPA filter.

Also shown in FIG. 6 are the earpieces 1518 and how they are attached to the face shield. The earpieces are attached to a mount 1546 that is further attached to the face shield. The earpieces can be reversibly removed and reattached to the mounts such as when they may need to be washed or replaced. The earpieces may be attached by hook-and-loop fasteners, an adhesive, snaps, or other mechanism.

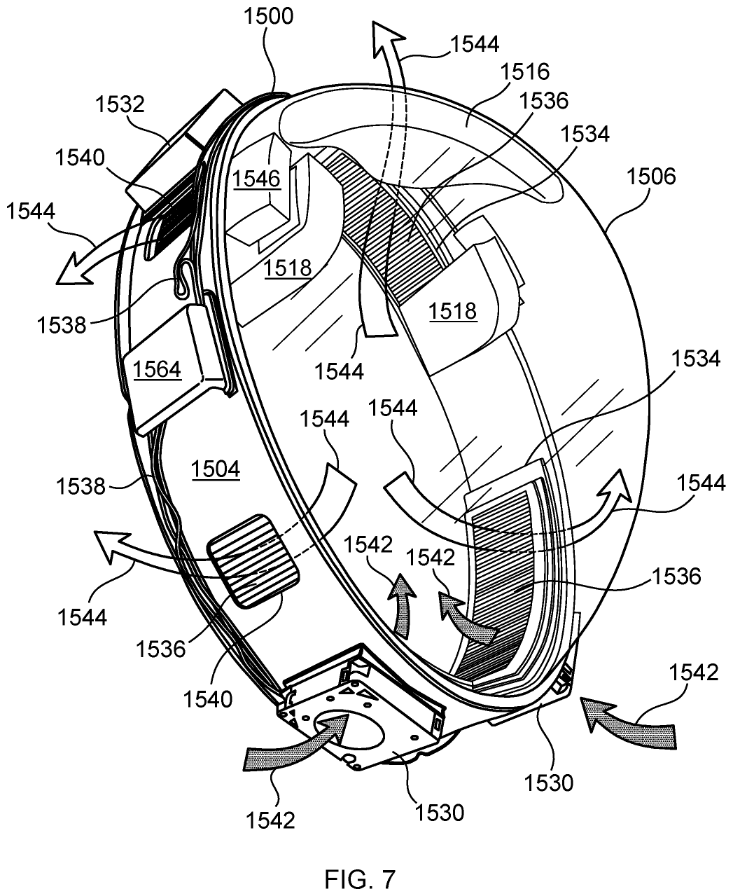

FIG. 7 is a perspective view of the variable flow head covering device (VFHCD) 1500 without the fabric and illustrating positive air flow, according to an embodiment of the disclosure. As illustrated in FIG. 7, air movers, such as fans, can pull ambient air into the VFHCD device through the fans from outside of the device forming a negative air flow. This is illustrated by arrows 1542. The air that enters the device passes through a filter 1536 located in a filter assembly 1534. Air that is in the device and exhaust air from a user may be exhausted through a filter and out an air outlet 1540. This exhaust air is represented by arrows 1544. Each fan is situated directly over a port. There are twice as many additional ports as ports that are situated over the fans. As illustrated in FIG. 7, there are two fans attached to the frame and each fan is located over a port. There are an additional four more ports 1540 to allow for unrestricted air flow that are not located over a fan. As explained previously herein, many different combinations of air movers may be used that pull air in the device or pull air out of the device.

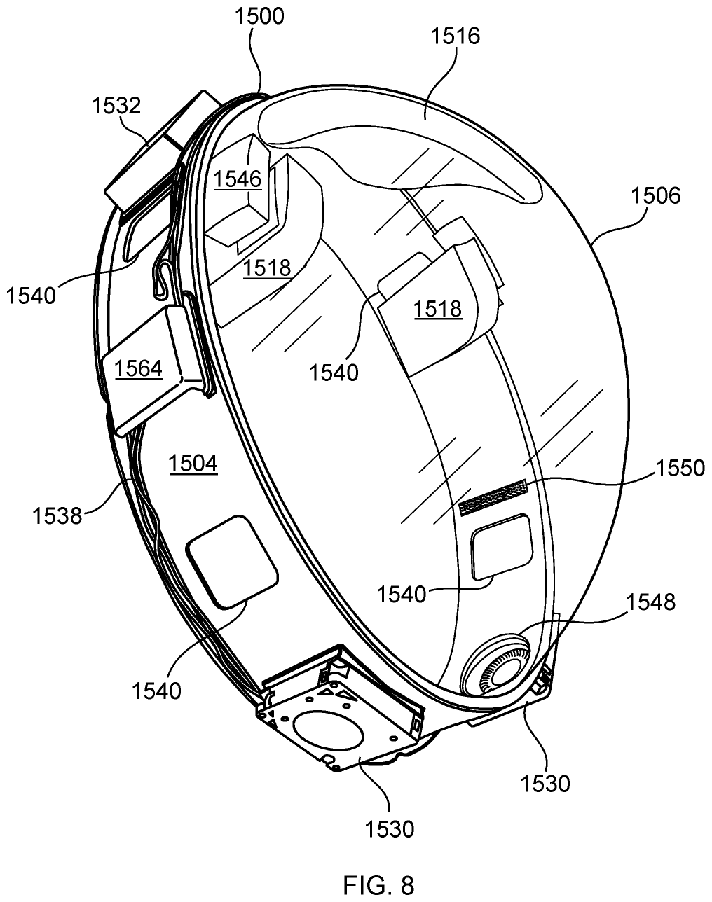

FIG. 8 is a perspective view of the variable flow head covering device (VFHCD) 1500 without the fabric and filter assemblies, according to an embodiment of the disclosure. Also shown in this view, inlet and outlet ports can be seen. A circular port 1548 can be seen that is located next to a fan 1530. The port may also be square or rectangular-like in shape. Also shown is a hook and loop fastener strip 1550 on the inner side of the frame to where a filter assembly may be attached to. Other devices may be used to attach the filter assembly.

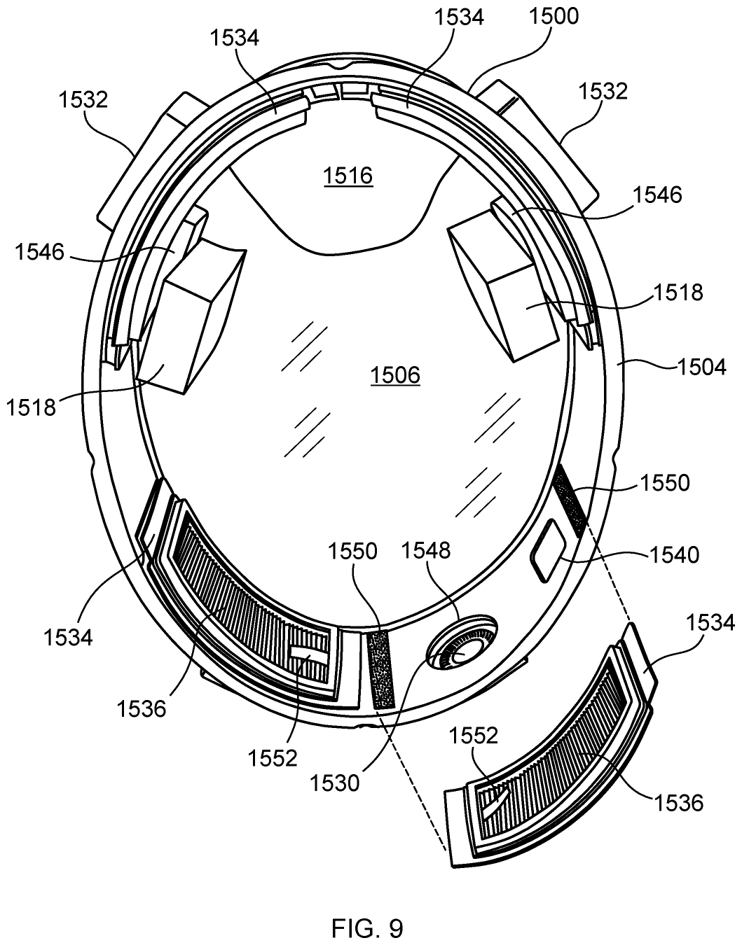

FIG. 9 is a bottom view of the underside of the variable flow head covering device (VFHCD) 1500 without the fabric and showing how the filter assemblies are attached, according to an embodiment of the disclosure. In this view, a filter assembly 1534 has been removed and showing how it sits in the frame as one of four filter assemblies. A hook and loop fastener strip is located on either side of the ports 1540, 1548. Each of the filter assemblies near the bottom of the frame nearest the mouth of a user spans both ports. The filter assemblies at the top of the frame only span a single port 1540. The filter assemblies may be reversibly removed and reattached.

The filter assemblies further comprise a tab 1552. The tab may be used to grab and pull the filter assembly off the hook and loop fastener strips and away from the frame. The filter assemblies have a radius of curvature similar to the radius of curvature of the frame in order to form a uniform distance along the length of the filter assembly between the filter assembly and the frame.

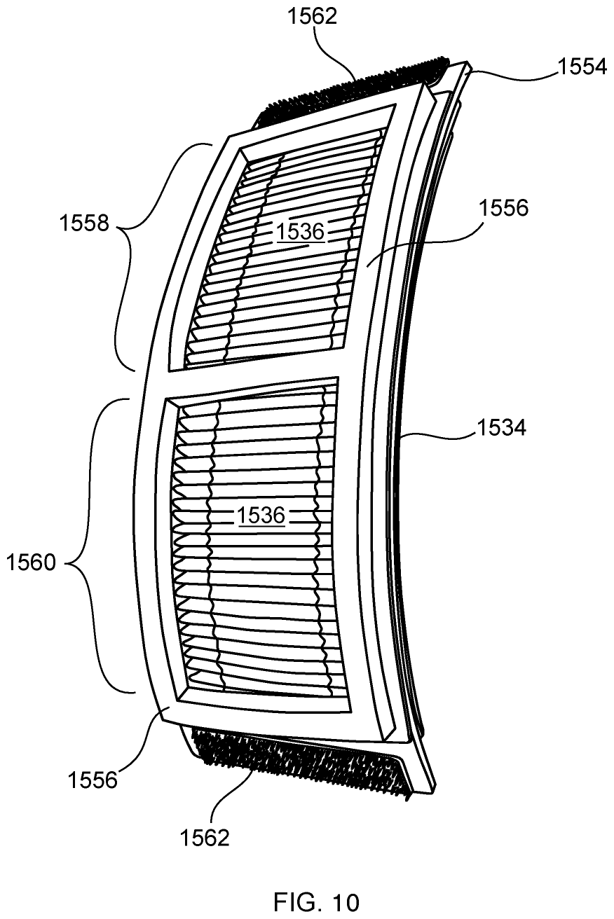

FIG. 10 is a close-up view of a filter assembly 1534, according to an embodiment of the disclosure. The filter assembly comprises a rigid support 1554. The support may comprise a polymer such as polystyrene (PS), high or low density polyethylene, polypropylene (PP), polyacrylonitrile, acrylonitrile butadiene styrene (ABS), polyvinyl chloride (PVC), polycarbonate (PC), polyethylene terephthalate (PET), polytetrafluoroethylene (PET), polymethylmethacrylate (PMMA), polyetheretherketone (PEEK), polyamide, polyimide, or a combination thereof. The support may comprise a metal such as aluminum. The filter assembly comprises a compartment further comprising a filter 1536 that spans the length of the assembly.

The filter assembly further comprises a gasket 1556. The gasket is preferably a soft and flexible material that can form a seal between the filter assembly and the surface of the frame. The gasket may comprise a foam rubber-like material. The gasket can be designed to form a first area 1558 and a second area 1560 wherein the first area is divided from the second area. The first area covers an inlet port and the second area covers an outlet port in the frame. The gasket can substantially prevent inlet air from entering an outlet port and outlet air from entering the inlet port.

The filter assembly further comprises an attaching device to attach the filter assembly to the inner surface of the frame. In a preferred embodiment as illustrated in FIG. 9, the attaching device is a hook-and-loop fastener such as a hook and loop fastener strip 1562. Strip 1562 connects to a receiving strip 1550 located on the frame.

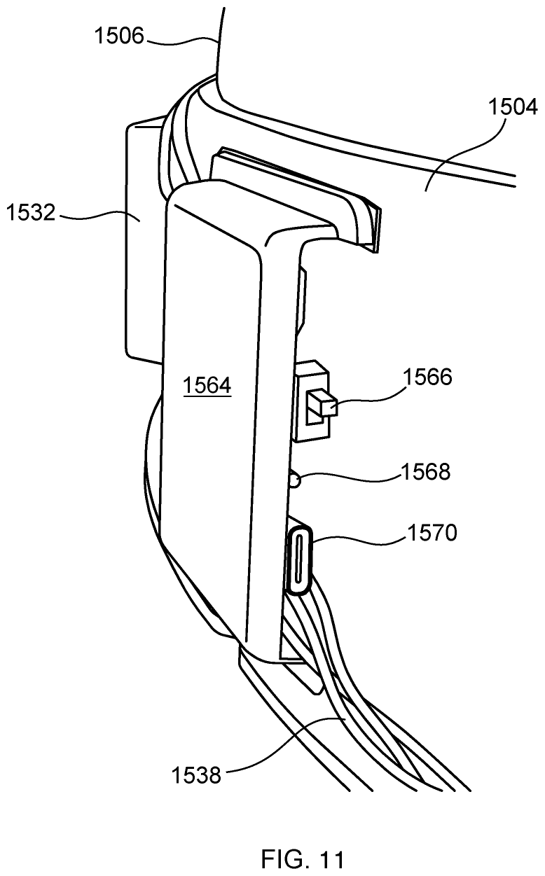

FIG. 11 is a close-up view of the control box 1564, according to an embodiment of the disclosure. The control box is in electrical communication with a battery pack and an air mover. The control box comprises an on/off air mover switch 1566, LED indicator light 1568, and charge port 1570. Other controls may be in the control box such a flow or pressure sensor, an air flow controller, or a combination thereof to control other components of the device. In a preferred embodiment, the charge port to recharge the batteries in the battery pack is a USB-C plug. The charge port may be a USB-A, USB 3.0 A SS, USB B, USB 3.0 B SS, USB mini-A, USB mini-AB, USB mini-B, USB micro-AB, USB micro-B, or a USB 3.0 micro-B SS plug.

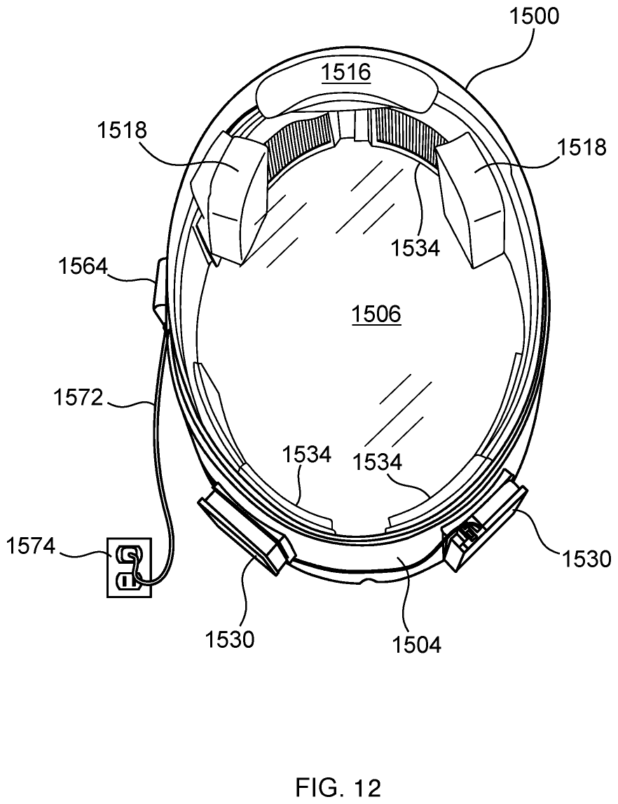

FIG. 12 is a view of the variable flow head covering device (VFHCD) being charged, according to an embodiment of the disclosure. In a preferred embodiment, the battery pack 1532 comprises one or more rechargeable batteries. The rechargeable batteries may comprise a rechargeable Li ion-based battery such as a LiCoO₂, LiFePO₄, LiMnNiCoO₂, LiNiCoAlO₂, or LiMn₂O₄-based battery. The rechargeable batteries may comprise a nickel-cadmium or nickel metal hydride battery. FIG. 12 illustrates a charge cord 1572 connecting to the charge port 1570 in the control box 1564 of the VFHCD to a wall socket 1574. The fabric component 1508 has been removed to better illustrate charging. When the fabric component is stretched over the frame, a charge cord may be connected to the charge port in the control box by way of access 1514 previously described herein. In other embodiments, the battery pack may comprise a non-rechargeable primary battery such as an alkaline cell.

### Alternative Fan Location in a Variable Flow Head Covering Device (VFHCD)

The following embodiments illustrate alternative locations for the fans in a variable flow head covering device (VFHCD).

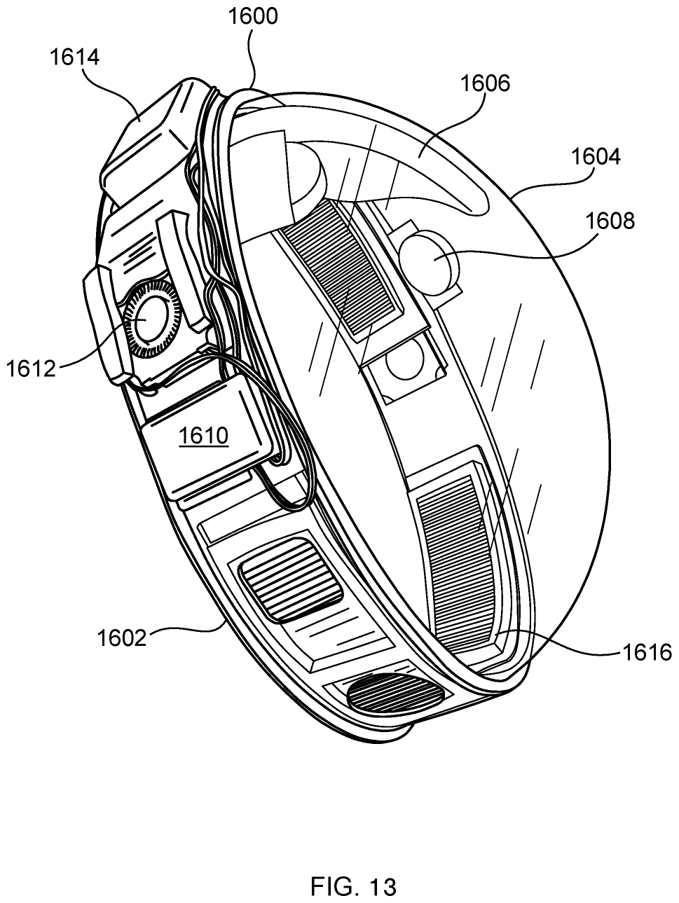

FIG. 13 is a view of a variable flow head covering device (VFHCD) 1600 with alternative fan locations, according to an embodiment of the disclosure. VFHCD 1600 is similar to the disclosed VFHCD 1500 embodiment described previously herein. The VFHCD 1600 embodiment in FIG. 13 does not include a fabric component in order to better view where the fans are placed. VFHCD 1600 similarly includes a frame 1602, transparent face shield 1604, resting pad 1606, earpieces 1608, control box 1610, fans 1612, battery pack 1614, and filter assembly 1616.

In this embodiment, the fans 1612 are moved towards the top of the frame near the battery pack. In the VFHCD 1500 embodiment they are near the mouth of the user. By moving the fans toward the top of the frame, the weight distribution of the device is improved in the VFHCD 1600 embodiment.

### Flip Up Face Shield for a Variable Flow Head Covering Device (VFHCD)

The following embodiments describe a design of a VFHCD with a face shield that can easily be opened and closed for access to the face of a user.

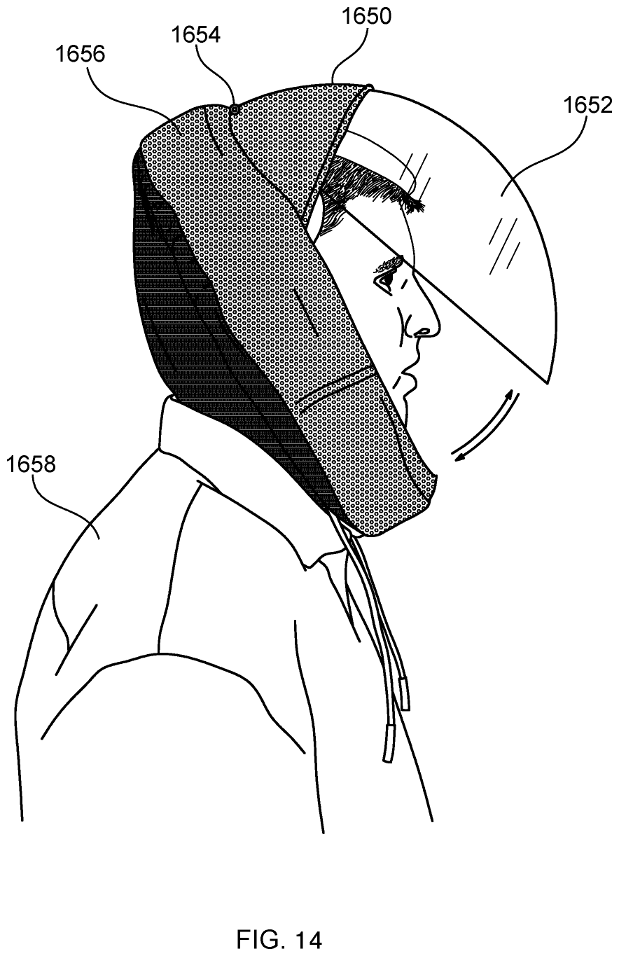

FIG. 14 is a side view of a user wearing a variable flow head covering device (VFHCD) 1650 with an opened face shield, according to an embodiment of the disclosure. The face shield 1652 is connected by a movable joint, such as the depicted simple hinge 1654, underneath the fabric component 1656 to allow for the face shield to be easily opened without removing the face shield entirely from the VFHCD. Alternatively, the movable joint may be a fabric, strap hinge, butt hinge, concealed hinge, piano hinge, offset hinge, overlay hinge, hidden barrel hinge, or a scissor hinge. In a preferred embodiment, the movable joint is a spring-loaded hinge. The spring-loaded hinge can hold the face shield open without the user having to do so. The face shield can be readily opened and closed for quick access to the face of a user 1658. The face shield may be able to snap in and out of the frame as it is opened and closed to secure the face shield. The fabric may be flexible or slide up the face shield to allow for opening of the face shield.

In other embodiments, the moveable joint may be located at the bottom of the face shield and connected to the bottom of the frame. The moveable joint may be located on either side of the face shield such that the face shield can be opened from the right or left of the user. Preferably, the VFHCD 1650 includes a latch or other locking means, such as magnets, to keep the face shield in place when not opened.

### Environmental Control for a Variable Flow Head Covering Device (VFHCD)

The following embodiments describe systems and methods to provide a controlled temperature and breathing environment within an HCD by conditioning the air within the HCD with an environmental control component. The environmental control component can control the air flow, temperature, or humidity or a combination thereof within the device.

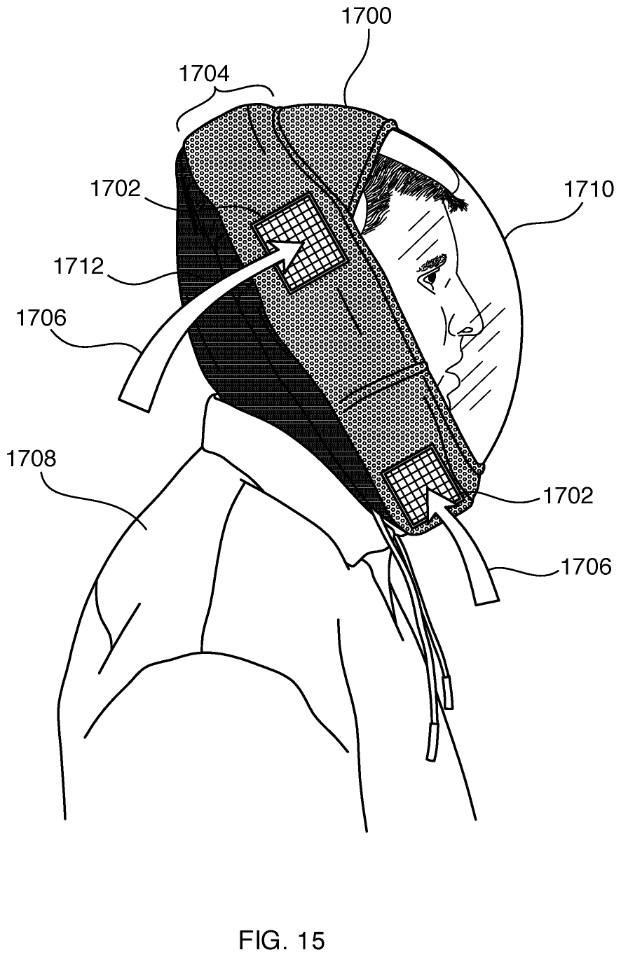

FIG. 15 is a side view of a user wearing a variable flow head covering device (VFHCD) 1700 with a pocket 1702, according to an embodiment of the disclosure. One or more pockets are preferably located over an intake filter or intake fan where air passes through before entering the VFHCD. The pockets are located on the permeable portion 1704 of the fabric.

The pocket may further comprise a thermoelectric cooler. The thermoelectric cooler may be designed to heat or cool incoming air 1706 for the user 1708. The thermoelectric cooler may be combined with a heat exchanger device to increase efficiency of heat transfer between incoming and exhaust air. The thermoelectric cooler may be used to control the temperature of the air to prevent fogging on the face shield 1710 or humidity build-up in the VFHCD. The inner surface of the face shield may comprise an anti-fogging layer. The thermoelectric cooler may operate on the principle of the Peltier effect.

The pocket may comprise an energy recovery or heat recovery device. Such a device would heat incoming intake air with outgoing exhaust air in order to maintain a comfortable environment within the VFHCD as described herein. The pocket may also contain an energy recovery device.

The pocket may comprise a sensor that detects one or more harmful or poisonous gases as the gases enter the VFHCD. The harmful gases may include CO₂, CO, NO_{R}, radon, or methanethiol. The pocket 1702 may also contain one or more sensors.

The depicted VFHCD further includes a water reservoir in the pocket. The water reservoir acts as a water source to the neck fabric wherein the water may be wicked by the neck fabric to provide evaporative cooling for the user to provide cooling to the neck area and cool air to breathe.

The VFHCD described herein may comprise a compartment containing a chilled mass such as ice. Incoming air is cooled as it passes over the ice and into the device. As the ice melts, the water is evaporated as the air passes over which can provide a further mode of cooling.

In some embodiments, a pocket may be located inside the fabric component 1704 or inside the VFHCD.

Air flow in the VFHCD embodiment in FIG. 15 occurs as follows. Incoming air 1706 from the environment is pulled in by one or more fans and passes through the pocket 1702 followed by a filter wherein particulates are removed. The air is pulled or pushed in by negative or positive air flow. Exhaust air from the user may then be exhausted through an exhaust filter located in the frame as previously illustrated herein. Air pressure differences may be detected by one or more sensors.

The VFHCD described herein may further include a fluid atomizer or mister. The atomizer may use water in the water reservoir to provide a mist of water inside a VFHCD. A VFHCD described herein may further include an environmental control device that can be used by a user to control the temperature inside the device by raising or lowering the temperature. The environmental control device may further comprise a source of water vapor to increase the humidity of the air inside the device.

The VFHCD described herein may further include a heater. The heater can heat the air inside a VFHCD. The heater may be an electric resistive heater. The VFHCD described herein may further include a chiller to chill the air inside a VFHCD.

In some embodiments, the fabric components described herein may comprise a phase-change material, such as that deployed in high-end sport clothing. The phase-change material, which may be encapsulated in the fabric of the VFHCD or held in reservoirs elsewhere in the VFHCD, works by reversibly storing and releasing heat at pre-defined temperature ranges. In the most common example, the phase change material is used to retain heat in a device designed to be used in sub-zero environments. The material, such as a paraffin or lipid, melts when in an environment with a temperature above a certain point. This melting is endothermic, so the melting cools the inside of the device. When the device is in a colder environment, the material solidifies, e.g., crystallizes, which is an exothermic process, thus warming the inside of the device.

Another temperature-affecting technology that may be incorporated into the impermeable fabric portion 1712 is one that is designed to wick perspiration away from the user. As that perspiration evaporates, the user is cooled thereby. One commercial example of such technology is available from Arctic Cool® in their products sold as HydroFreeze™.

In other embodiments, the VFHCD further comprises a compressor to provide heating or cooling to the device. The compressor may be held in a backpack worn by the user. Preferably, the compressor provides heating or cooling directly to the neck area of the user. The compressor may comprise a 24V DC compressor. Alternatively, the compressor heats and/or cools the air as it is brought into the device.

A VFCD described herein may further include a multi-speed air moving system. The multi-speed air moving system may be a dual speed fan. If a pre-set environmental threshold or parameter is exceeded within the HCD, such as temperature or humidity, the air moving system increases to a higher speed to improve the environment by increasing air flow within the HCD. The air mover may be adjusted continually to maintain a desired target atmosphere in the device.

A VFHCD described herein may include one or more sensors to provide filter end of useful life alerts to the user based on at least one of age of the filter, increased head pressure on the filter and optical readings indicating a dirty filter.

In some embodiments, wearable electronics may be embedded in the neck fabrics, frame, air moving device, or face shield to provide environmental and thermal monitoring within the devices described herein. The wearable electronics may also monitor the temperature, air flow, and air conditions inside the device. The electronics may be powered by the power source used for the air moving device or a separate power source may be used. The electronics may include one or more sensors may be included to detect for air leaks around the fabric portion sealed around the neck area.

### Communication Component for a Variable Flow Head Covering Device (VFHCD)

The following embodiments include a communication component or hardware with a VFHCD. This communication hardware is used to provide audio and/or video capabilities for the user in a VFHCD. As such the communication hardware facilitates communication with other people who may or may not be wearing an HCD, as well as news, alerts, weather, entertainment, and other services to the user. The communication hardware may also facilitate communication with a smart device such as a smart phone, tablet, or wearable.

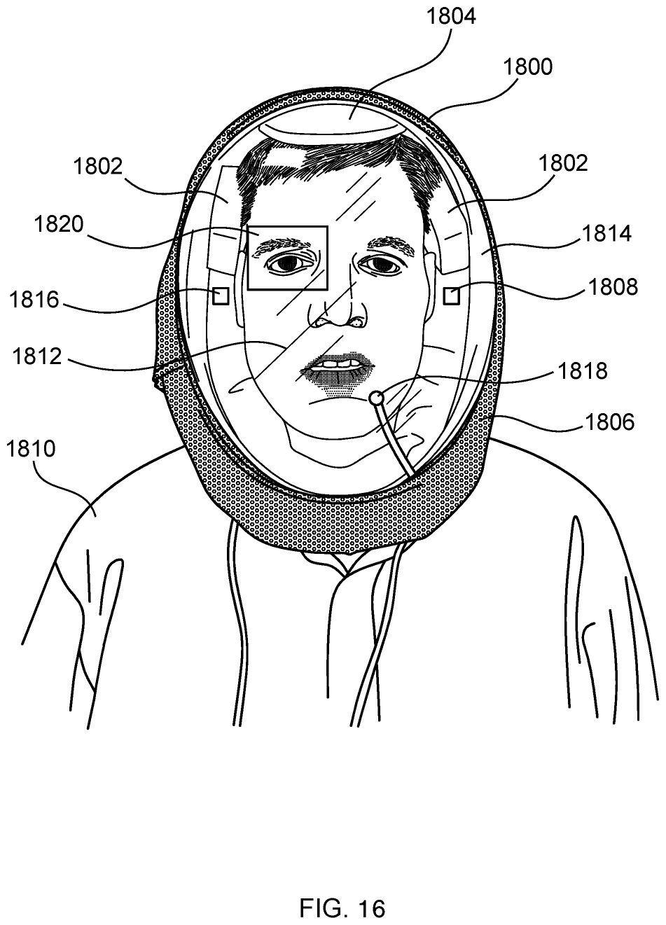

FIG. 16 is a front view of a user wearing a variable flow head covering device (VFHCD) 1800 equipped with communication hardware components, according to an embodiment of the disclosure. VFHCD 1800 is similar to other devices disclosed herein comprising a noise reduction device 1802, head rest 1804, and fabric component 1806. The communication hardware may be connected to the internet. The communication hardware may be wirelessly connected to a smart phone. The communication hardware further comprises Bluetooth technology for wireless communication with the smart phone. VFHCD 1800 comprises a speaker 1808. The speaker 1808 communicates audio and may be an earphone, headphone, ear bud, or an earpiece. Speaker 1808 allows a user 1810 to better hear sounds coming from outside the device or to communicate with another person. The speakers may be used to communicate with someone specifically wearing a similar HCD. Speaker 1808 may be mounted on shield 1812 or frame 1814 near one ear. VFHCD 1800 may further comprise a second speaker 1816. Second speaker 1816 may also be mounted on the face shield or frame near the other ear. One speaker may be mounted on a rigid component inside of the VFHCD and a speaker mounted on a rigid component outside of the VFHCD. The speakers may be wired or use wireless technology such as Bluetooth™. The speakers may be connected to a device containing a library of music such as an mp3 player or smartphone.

VFHCD 1800 embodiment may further comprise a microphone 1818. The microphone can be used to capture audio signals outside the device. The microphone can be mounted on the face shield and could be wired or use wireless technology. One microphone may be mounted on a rigid component inside of the VFHCD and a speaker mounted on a rigid component outside of the VFHCD. This allows for easy and clear communication to others of the outside world. The microphone may be a voice activated microphone. The VFHCD may be equipped with Bluetooth® technology to allow for making and receiving phone calls or streaming to a device for music, video, etc such as with a smart phone or wearable smart device. Device to device audio connections could be privately paired, or public according to signal strength. This way, other users nearby will only be heard according to distance, like normal audio. The VFHCD may further comprise a speaker with an amplifier to amplify outside sounds or amplify the voice of the user to others outside. The VFHCD may further comprise a cellphone system utilizing speakers and a microphone. The communication hardware may comprise speakers to provide audio signals to the user and a microphone to capture sounds outside the device and an audio signal processor configured to process input from the microphone and provide noise-cancelling audio signals to the user through the speakers.

In some embodiments, a passive, non-electronic device may be used to enhance the hearing of a user of a VFHCD. For example, an “ear-outside-ear” type device may be used. An ear trumpet-like device may be used that is located near where the ears of the user would be located in the VFHCD and would penetrate and pass through the face shield or frame but would further comprise a membrane or diaphragm to add in transmitting sound but also prevent unfiltered air from entering or leaving the device.

The VFHCD 1800 may further comprise a universal serial bus (USB) port, of any type, or any other type of data and/or charging port.

The VFHCD may further comprise a video display such as a liquid crystal display (LCD), a light emitting diode (LED) display or an electrophoretic reflective display. Alternatively, the display may be formed by images projected onto a surface, such as the inside surface of the face shield. The display may be mounted on the other inner or outer surface of the face shield such that the display is not in the direct view of the user. The video display provides images for augmented reality, way-finding, Global Positioning System (GPS), maps, or environmental warnings.

The displays may be in the form of an optical head-mounted display (OHMD) 1820 that is mounted on the face shield. The OHMD (1820) may be “smart glasses” such as Google Glass or Apple Glass. An HCD described herein may comprise a holographic projection system to project a display onto the inner surface of the face shield. Any of the communication hardware devices described herein may be powered by a power source such as a battery pack mounted on the VFHCD or in the frame of the VFHCD. A solar cell can be used to charge the power source.

In some embodiments, the video displays may be used for gaming applications. The VFHCD may be integrated with a gaming console for a user to play E sports, adventure, or other games while wearing the device.

In some embodiments, the VFHCD may comprise a night vision device. The device may be slid down over the eyes and may be located inside or outside of the face shield. In some instances, the night vision device may be a stationary device mounted to the frame or face shield. In this instance, the VFHCD may only be used for night vision purposes.

The VFHCD may further comprise an antenna. The antenna may be used to pick up radio and other frequencies. The antenna may be sewed into the fabric component, coated onto the face shield, or inside the frame, or incorporated into the device in any manner. The antenna may be used to communicate with other users of an VFHCD.

The VFHCD may comprise one or more lights in the VFHCD. The lights may be LEDs and are to provide a lighted atmosphere for the user. This is particularly useful in dimly lit conditions inside or at night. In a preferred embodiment, the one or more lights are situated inside and at the top of the VFHCD though the lights may be located throughout the device. The lights may be configured to direct light rays in front of the face of the user. The lights may also be needed to indicate the presence of a user. One or more lights may be located on an outer surface of the device. This would be beneficial if using the device at night and act as a headlight for other to be able to see the user. The internal lights may be helpful for someone to view the face of the user in dimly lit environments.

A VFHCD described herein may further include a multi-speed air moving system. The multi-speed air moving system may be a dual speed fan. If a pre-set environmental threshold is exceeded within the VFHCD, such as temperature or humidity, the air moving system increases to a higher speed to improve the environment by increasing air flow within the device.

In some embodiments, the VFHCD comprises an audible alert to provide warnings to the user.

In some embodiments, the VFHCD further comprises an external electronically switchable display to display text or images to people who approach the user. This may be for users who are deaf.

### Automatic Air Mover for a Variable Flow Head Covering Device (VFHCD)

The following embodiments relate to air movers that automatically start when a user places a VFHCD over their head. The air mover automatically turns off when the user removes the VFHCD. The air mover may also adjust according to a pre-determined threshold.

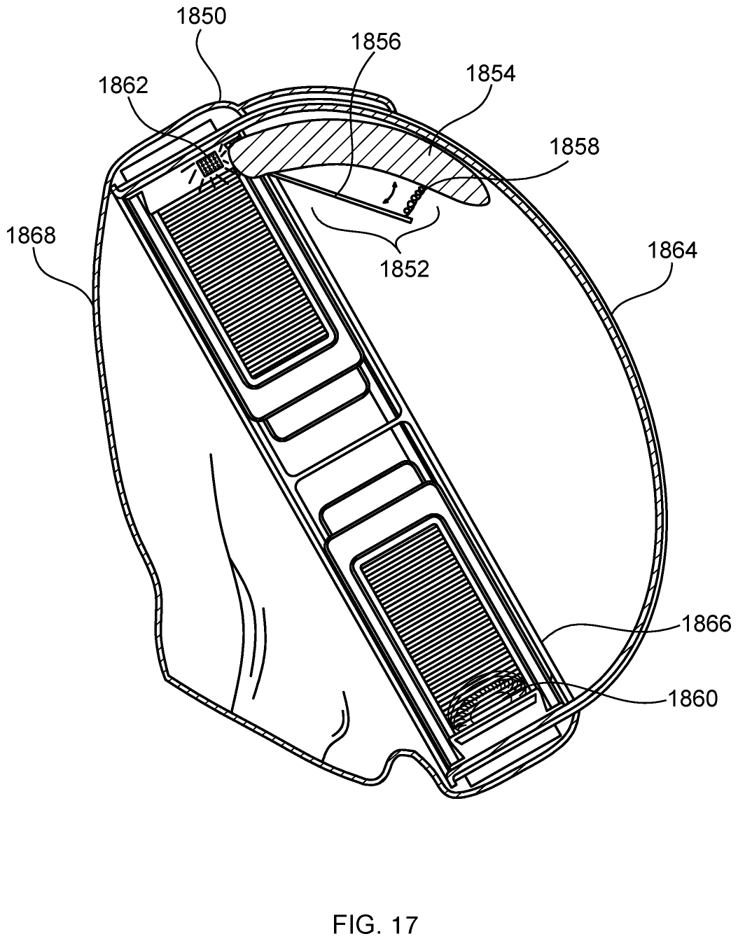

FIG. 17 is a cross-sectional view of a variable flow head covering device (VFHCD) 1850 equipped with an automatic air mover, according to an embodiment of the disclosure. VFHCD 1850 embodiment comprises a spring-loaded lever switch 1852. The lever switch is located at the top of the VFHCD near head resting pad 1854. The lever switch comprises a lever 1856. The lever switch further comprises a resilient device, such as the depicted spring 1858. In an exemplary embodiment, the lever may be a part of resting pad. The lever may protrude out of the resting pad such that when it is depressed, it retracts into the resting pad such that when a user places the device on, the user cannot feel the lever. The user instead feels the resting pad to provide a comfortable experience.

When the VFHCD 1850 is placed on the head of a user, the lever is depressed and pushed into the resting pad (such as a resting pad cavity) or other location so that it is not uncomfortable to a user. By depressing the lever, the pressure switch completes an electrical circuit such that power from battery pack comprising one or more batteries or other power source provides an electrical current to an air moving device, such as a fan 1860. The air mover then automatically turns on. When a user removes the device from their head, the lever is extended by the spring which breaks the electrical circuit between the air mover and power source which automatically shuts down the air mover.

VFHCD 1850 preferably comprises one or more sensors 1862. The sensor can detect the head of a user and sends a signal to turn on the air mover. The sensor may be a temperature sensor, pulse rate sensor, IR sensor, optical sensor, humidity sensor, proximity sensor, motion sensor, skin moisture sensor, force sensor, or a biometric sensor. Upon detection of the head of the user placing the device on, the automatic air mover turns on. This may be done by measuring the temperature of a user or a proximity sensor of a nearby object, such as the head of a user. When the device is removed, the sensor no longer detects the head of a user and the air mover then turns off. The sensor may be located anywhere within the VFHCD, such as on the face shield 1864, in the frame 1866.

The sensor may detect a change in the biometric data of a user which may be relayed to a controller. The controller would then adjust the air flow from an air mover until a pre-determined biometric data target is reached. The biometric data may include skin temperature, pulse rate, skin moisture, or oxygen saturation. A processor may also be combined to process the signals from the sensors.

The VFHCD may further comprise a controller that is configured to adjust the rate at which the air mover moves air. A sensor detects the air flow. When the air flow falls below a pre-determined threshold of air flow, the sensor relays the information to a controller that adjusts the rate of air flow from an air mover. The air mover increases the air flow until the threshold is reached. In some instances, the air flow may rise above a pre-determined threshold such that the controller decreases the air flow. The VFHCD further comprises a sensor for generating signals indicative of at least one of air pressure, ambient temperature, body temperature, skin moisture, blood oxygen saturation, respiration rate and pulse rate, and a processor for processing signals from the sensor and providing instructions to the controller to adjust the rate of the air mover according to predetermined parameters.

The HCD may further comprise a communication module for receiving signals relating to at least one of air pressure, ambient temperature, body temperature, skin moisture, blood oxygen saturation, respiration rate and pulse rate, and a processor for processing signals from the communication module and providing instructions to the controller to adjust the rate of the air mover according to predetermined parameters. The communication module is configured to receive signals from the user's smart device. The device is configured to communicate with an app running on a user's smart device, which app is configured to provide alerts to the user and to allow the user to adjust the rate of the air mover. The communication module is configured to receive signals from the user's wearable smart device.

The VFHCD may further comprise a sensor for generating signals indicative of the concentration of oxygen, and a processor for processing signals from the sensor and providing instructions to the controller to increase the rate of the air mover when the oxygen concentration of oxygen falls below a predetermined level. The device further comprises a user warning system, configured to alert the user when the concentration of oxygen falls below the predetermined level.

The VFHCD further comprises a sensor for generating signals indicative of the concentration of carbon dioxide, and a processor for processing signals from the sensor and providing instructions to the controller to increase the rate of the air mover when the concentration of carbon dioxide rises above a predetermined level. The device further comprises a user warning system, configured to alert the user when the concentration of carbon dioxide rises above the predetermined level. The device further comprises a second sensor for generating signals indicative of the concentration of oxygen, and wherein the processor processes signals from the sensor and the second sensor and provides instructions to increase the rate of the air mover when either the concentration of carbon dioxide rises above a predetermined level or the concentration of oxygen falls below a second predetermined level.

The VFHCD may further comprise two or more electrodes. The electrodes may be located in the fabric 1868, in the resting pad 1854, or elsewhere in the device where the skin of the user comes into contact with the electrodes. By coming into contact with the electrodes, the circuit is closed and a current is able to pass. This current is detected by a sensor that initiates the starting of the air mover.

In some embodiments, the air moving device may be combined with a head covering device that comprises a flip-up shield. The flip-up shield may be connected by a hinge to the frame, as previously illustrated herein in FIG. 14. The air moving device may shut off when the shield is flipped open by the user. The air mover may turn on when the shield is closed.

### Shroud for Variable Flow Head Covering Device (VFHCD)

The following embodiments include a shroud-like component that can at least partially cover the transparent face shield in a VFHCD when a user desires to have a darkened environment to relax, sleep, or for enhanced privacy. In some embodiments, the shroud completely covers the transparent face shield, while in others, the shroud only partially covers the transparent face shield, so as to provide privacy, while allowing some light inside the device.

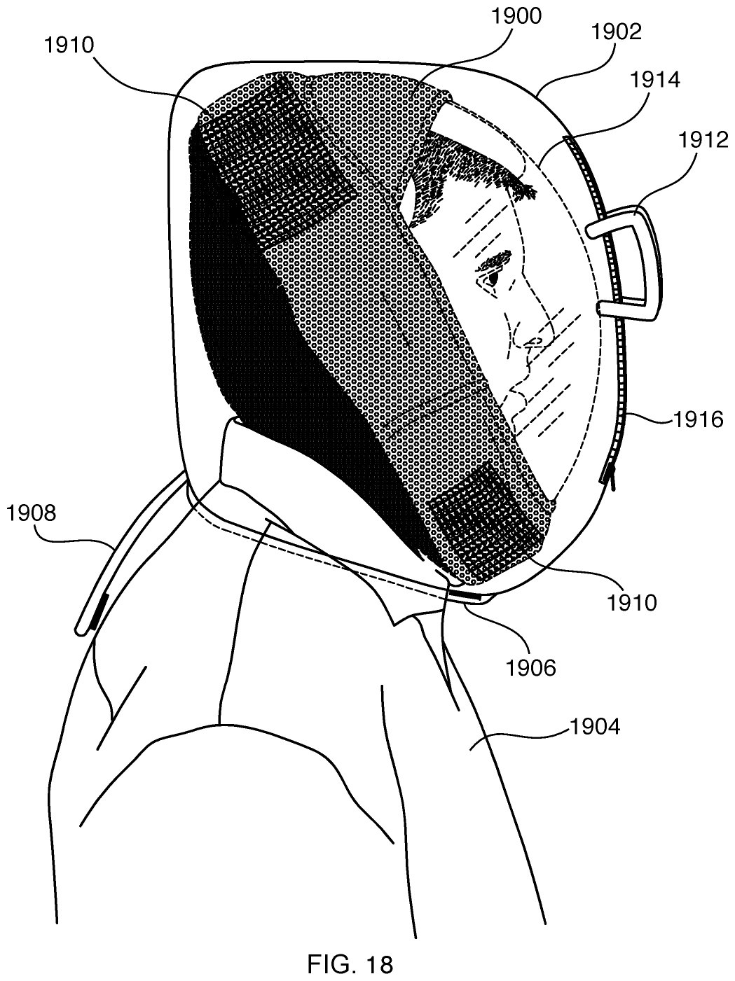

FIG. 18 is a side view of a user wearing a variable flow head covering device (VFHCD) 1900 equipped with a shroud 1902, according to an embodiment of the disclosure. A user 1904 wearing a VFHCD 1900 further comprises a shroud 1902 that is placed or slipped over the HCD. The shroud comprises a flexible, stretchable, or stiff fabric and may also be referred to as a cover, blackout cover, sleep cover, or privacy cover. In preferred embodiments, the shroud is opaque. The shroud may comprise a polymeric material such as nylon, rayon, spandex, lycra, viscose, or a natural fabric such as cotton or wool. Preferably, the shroud comprises a sealing device 1916 to seal shut the shroud when placed over a VFHCD. The sealing device may be a zipper as shown in FIG. 18 but may also be hook and loop fastener, a drawstring, laces, or other device. In some embodiments, the shroud may be stretched and fit snuggly over the VFHCD such as how a sock fits over a foot. In a preferred embodiment, the shroud has a much higher porosity and higher permeability than the fabric component in a VFHCD to allow for unrestricted air low. The shroud may have twice as high air permeability than the fabric component. The shroud may be constructed entirely of mesh except the portion that covers the face shield. The shroud may partially or completely cover the face shield in a VFHCD. The shroud may partially cover the transparent face shield so as to provide privacy, while allowing some light inside the device.

The shroud 1902 further comprises an opening 1906 so that the head of a user or a user wearing a VFHCD can pass. The opening comprises a flap 1908 that can be closed when the user is not using the VFHCD. In a preferred embodiment, the flap may be held shut using hook and loop fastener pads but may also be a zipper, clasps, laces, or buttons.

The shroud 1900 further comprises one or more openings 1910 for intake or exhaust air. The openings allow air to pass through to and away from the shroud, through the VFHCD and to the user wearing the VFHCD. The air openings preferably are a mesh material that minimally restricts air flow. The openings allow unrestricted air flow by one or more air moving devices in the VFHCD while a user safely relaxes or sleeps.

The shroud further comprises one or more optional handles 1912. The handles are to provide a way for a user to carry the device when stored or toted in the shroud. The shroud further protects the face shield 1914 from getting scratched or damaged.

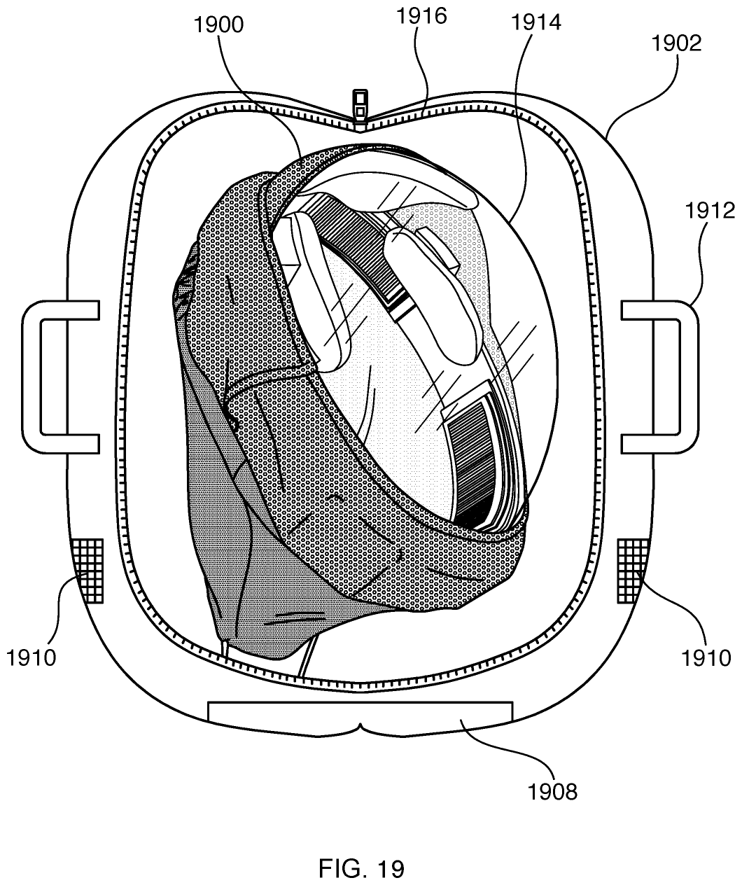

FIG. 19 is a view of an empty variable flow head covering device (VFHCD) 1900 placed in a shroud 1902, according to an embodiment of the disclosure. FIG. 19 shows how the VFHCD fits into a shroud 1902 which can also act as a carrying case. In this view, the flap 1908 is closed.

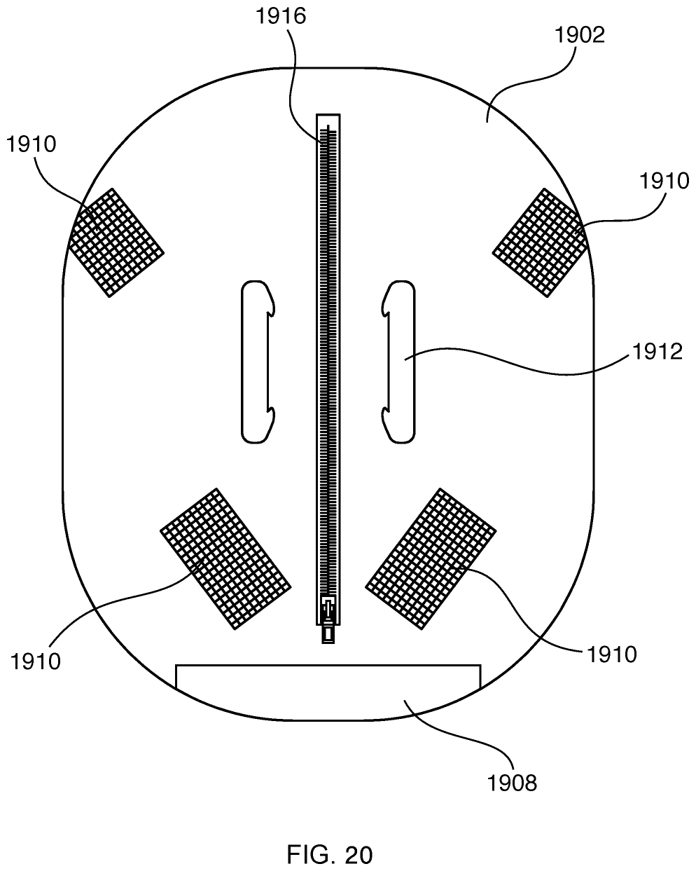

FIG. 20 is a view of a closed shroud 1902, according to an embodiment of the disclosure. FIG. 20 illustrates a closed shroud 1902 with zipper 1916 closed. In this view, the flap 1908 is closed. The shroud comprising a VFHCD inside may be stored until next use or carried to a different location while protecting the face shield from getting scratched or damaged.

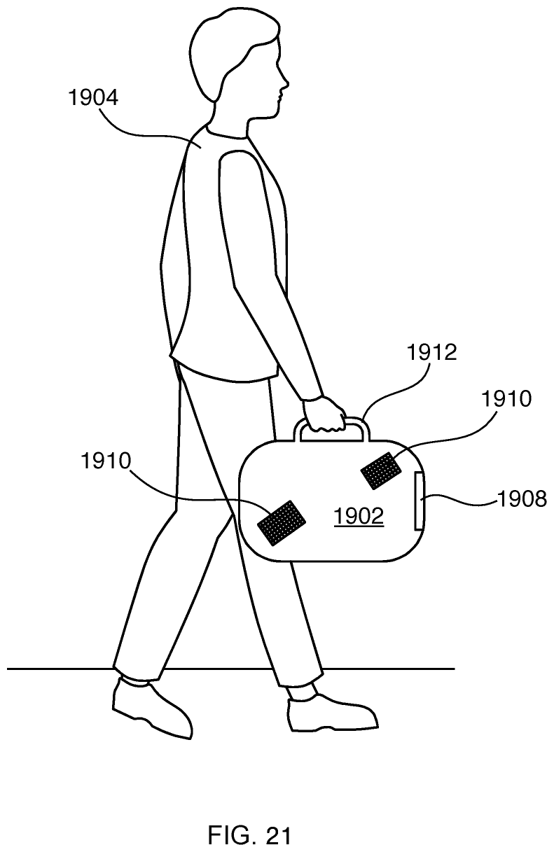

FIG. 21 is a view of a variable flow head covering device (VFHCD) in a shroud 1902 being carried by a user, according to an embodiment of the disclosure. FIG. 21 further shows a user 1904 carrying a shroud 1902 by the handles 1912. In some embodiments, shroud may instead be just a carrying case and not be used for a blackout device. In some embodiments, the carrying case may be comprised of a rigid material. The shroud can serve as a protective cover for the device when not in use.

### Washable Fabric for a Variable Flow Head Covering Device (VFHCD)

The following embodiments describe a fabric for use in the fabric component of a variable flow head covering device (VFHCD) that is removable, washable, the materials of construction can be modified, and the appearance is customizable by a user.

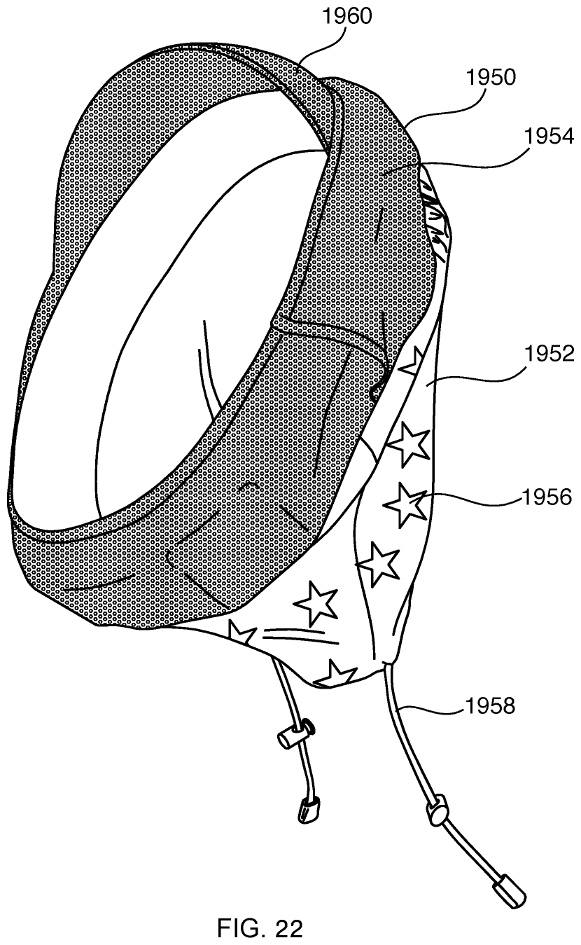

FIG. 22 is a view of a washable fabric component (WFC) 1950, according to an embodiment of the disclosure. The WFC for a VFHCD can be removed after use, washed of any particulates removed during operation and reused. The fabric comprises a thread count of about 100-1000. In an exemplary embodiment, a portion of the fabric is impermeable to air 1952 and another portion 1954 that is permeable to air. The length of the longitudinal axis of the transparent face shield is about twice as large as the diameter of the head opening in the fabric component.

The appearance of the WFC is also customizable by a user. FIG. 22 illustrates a design embodiment of stars printed on, woven into or sewn into the fabric 1956. The design may be any other pattern such as stripes or other geometric patterns. The fabric may comprise the colors or logos of a college, high school, or professional sports team. The fabric may comprise the colors or flag of a country or state.

The WFC may comprise an absorbent material. The absorbent material can soak up a liquid spill. The absorbent material may comprise linen, cotton, modal fabric, rayon, wool, French terry toweling fabric, fleece, bamboo fabric, sponge, microfiber, hydrogel, plush fabric, hemp, or flannel.

The WFC may comprise a port for access to the mouth or nose area of a user. The port may be a diaphragm. The port can allow a straw to pass through while maintaining a seal to prevent air leakage.

The WFC comprises a securing device 1958 to secure the fabric around the neck of a user. The securing device may be stretchable to seal. The securing device may be a stretchable hem, stretchable band, or a drawstring as shown in FIG. 22.

The WFC 1950 may comprise a stretchable backing. The stretchable backing acts as an expandable opening for ease of opening and ease of placement over the head of a user. The stretchable backing is expandable while the rest of the fabric may be stiff and non-stretchable. The stretchable backing may comprise a stretchable silicone material. The silicone backing material may comprise a spring steel strip to provide tension to secure the HCD in place on the head of a user.

FIG. 22 further illustrates a second fabric component 1960 located at the top of the WFC. The second fabric component may be permeable or impermeable to an air flow.

### Electromagnetic Radiation (EMR) Filtering Face Shield for a Variable Flow Head Covering Device (VFHCD)

The following embodiments describe designs and methods to filter electromagnetic radiation hitting the face shield from a user wearing a variable flow head covering device (VFHCD).

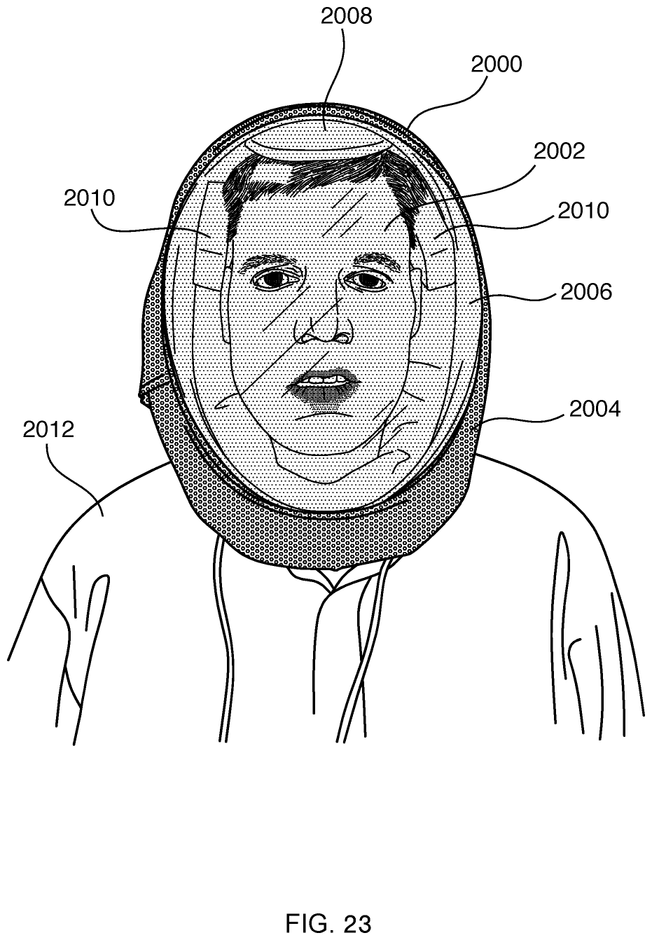

FIG. 23 is a view of a variable flow head covering device (VFHCD) 2000 with an electromagnetic radiation filtering face shield 2002, according to an embodiment of the disclosure. VFHCD 2000 is similar to other HCDs disclosed herein comprising a fabric component 2004, frame 2006, head rest 2008, and noise reduction devices 2010. FIG. 23 further shows an electromagnetic radiation (EMR) filtering face shield 2002. The face shield comprises a layer that completely or partially covers the face shield that can be tuned to selectively filter one or more wavelengths or wavelength ranges of EMR, such as ultra-violet (UV), visible, or infrared (IR) radiation. In a preferred embodiment, face shield 2002 filters UV light only. In some embodiments, particularly those used for healthcare environments, or for travel, the transparent face shield may be transparent to infrared (IR) radiation to allow for determination of the temperature of a user 2012.

Face shield 2002 may comprise a photochromic layer. The photochromic layer reversibly darkens in the presence of UV radiation, such as from sunlight. The photochromic layer reversibly darkens in the presence of UV-A light (wavelengths of 320-400 nm). The photochromic layer reversibly darkens in the presence of both UVA and UVB light. The photochromic layer comprises an inorganic material such as AgCl. The photochromic layer comprises an organic material such as an oxazine or a napthopyran-based material. The photochromic layer may comprise the material used in Transitions® lenses.

The face shield may comprise a polarizing filter layer. The polarizing layer may be a linear polarizer or circular polarizer. The polarizing layer may be tuned to filter visible, UV, IR, radio waves, microwaves, or X-rays.

The face shield may comprise an electrochromic layer. The electrochromic layer comprises an inorganic material such as WO₃. The electrochromic layer comprises an organic material such as a conducting polymer or a viologen-based material. The conducting polymer may be a polyaniline, polythiophene, poly(3,4-ethylenedioxythiophene) (PEDOT), or a polypyrrole-based polymer, or combinations thereof.

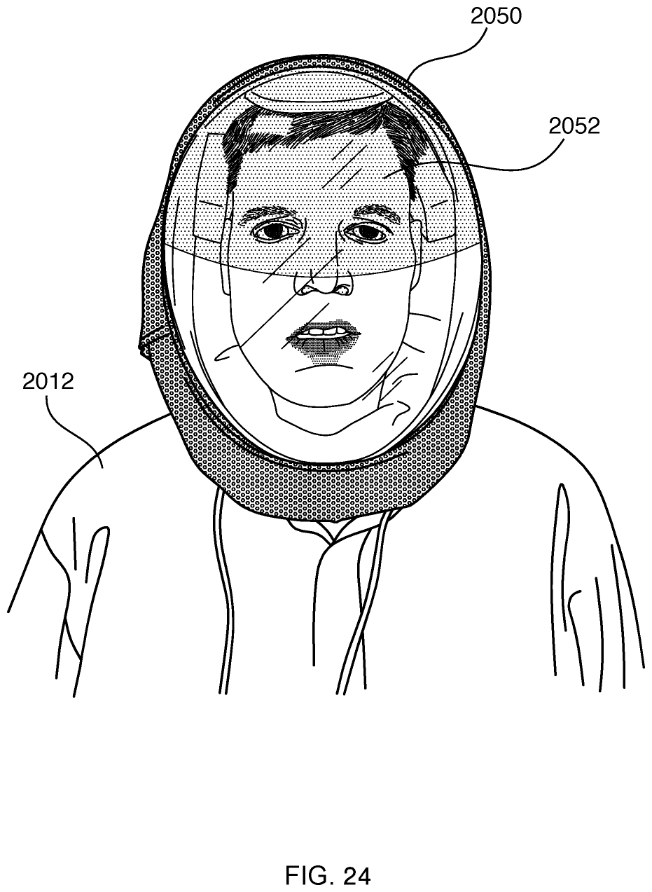

FIG. 24 is a view of a variable flow head covering device (VFHCD) 2050 with a patternable electromagnetic radiation filtering face shield 2052, according to an embodiment of the disclosure. Face shield 2052 comprises a layer that partially covers the face shield to filter one or more wavelengths or wavelength ranges of EMR, such as UV, visible, or IR radiation. The face shield comprises a patternable EMR filtering layer such as a patternable photochromic layer, electrochromic layer, or polarizing layer.

FIG. 24 shows the EMR filtration layer on the top half of the face shield 2052. The EMR layer acts as a sunshade wherein a user may not need to wear a pair of sunglasses behind the face shield. Additionally, the partial EMR filtration layer helps to keep the user cool by reflecting EMR radiation from the top of the head and eyes of a user. Only blocking a portion of the light that passes through the face shield allows the VFHCD 2050 to be used indoors.

In some embodiments, a moveable visor may be used instead of a permanent EMR filtering layer on the face shield. Such a visor can be mounted either on the inside or on the outside of the face shield. In either event, the moveable visor may be slid across the face shield. The visor is moveable and can be moved to overlap at least a portion or all of the face shield. The moveable visor may be opaque to all EMR. The moveable visor may be tuned to be opaque to only select wavelengths or ranges of wavelengths such as UV, visible, IR, X-rays, or microwaves. At least a portion of the transparent face shield is opaque to ultra-violet (UV) radiation. The moveable visor may be part of the frame wherein the visor may be slid up and down or side to side over the face shield. In other embodiments a detachable visor may be used to block specific wavelengths of light. The detachable visor may be attached and unattached with a device such as hook and loop fastener, buttons, clips, screws, or other mechanism. The visor may be on the inside or outside of the face shield.

Safety Features for a Variable Flow Head Covering Device (VFHCD)

The following embodiments describe a variable flow head covering device (VFHCD) with safety features to protect a user from harm where the risk of injury is high.

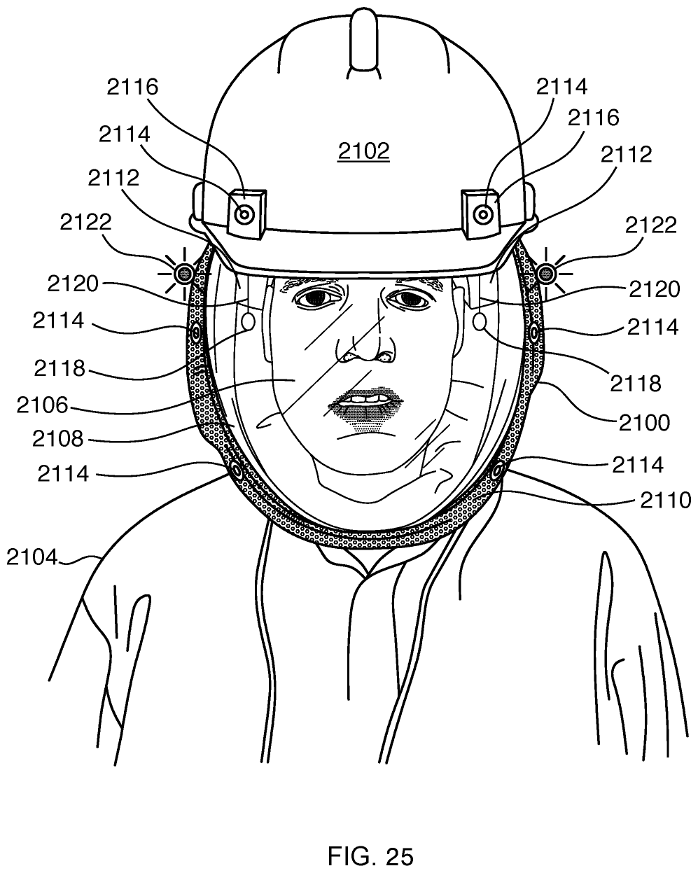

FIG. 25 is a front view of a variable flow head covering device (VFHCD) 2100 integrated with an impact resistant top portion 2102, according to an embodiment of the disclosure. In some instances, a user 2104 may not only desire or require a controlled atmosphere or breathing environment provided by the VFHCD, but also further safety if the user is working in a setting where there may be hazards, such as occupational hazards. For example, the setting may be a construction site, manufacturing plant, mining site, oil rig, or a natural disaster zone. The impact resistant top portion is also referred to as a hard hat to protect the head from injury due to falling objects, impact with other objects, debris, rain, and electric shock. Suspension bands inside the helmet spread the helmet's weight and the force of any impact over the top of the head.

VFHCD 2100 in FIG. 25 is similar to other HCD embodiments described herein but is further integrated with a hard hat. VFHCD 2100 comprised of a face shield 2106, frame 2108, fabric component 2110, noise reduction devices 2112 and hard hat 2102 may be separate components. The VFHCD and hard hat may be joined together in such a way so that the hard hat stays in place on top of the device and does not come off. A locking mechanism may be used to secure the device and hard hat together into a single rigid structure such as snaps, screws, straps, or other mechanism. The locking mechanism may be manipulated to convert the single rigid structure back into separate components. In other embodiments, the VFHCD and hard hat may be of unitary construction where the frame and hard hat are one piece and only the fabric, filters, or fan may be removed to be able to be cleaned or replaced. The hard hat may comprise a polymer or metal.

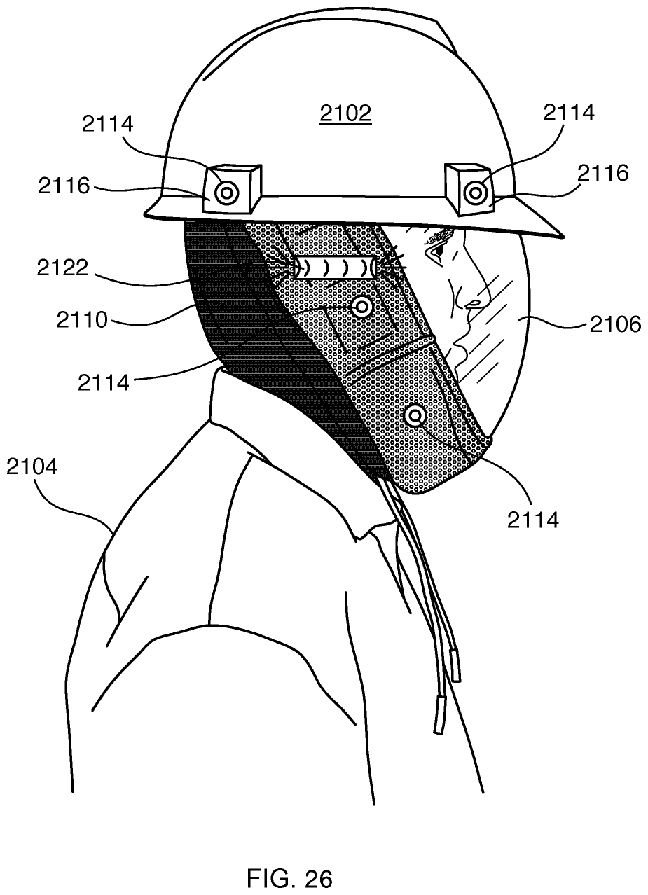

FIG. 26 is a side view of a variable flow head covering device (VFHCD) 2100 integrated with an impact resistant top portion 2102, according to an embodiment of the disclosure. The hard hat may be a Type I hard hat that is intended to reduce the force of impact resulting from a blow only to the top of the head. The hard hat may be a Type II hard hat that is intended to reduce the force of lateral impact resulting from a blow which may be received off-center, from the side, or to the top of the head. The hard hat may be a Class E electrical hard hat that is designed to reduce exposure to high voltage conductors and offer dielectric protection up to 20,000 volts (phase to ground). The hard hat may be a Class G general hard hat that is designed to reduce exposure to low voltage conductors and offer dielectric protection up to 2,200 volts (phase to ground). The hard hat may be a Class C hard hat. Class C conductive hard hats differ from Class E and G hard hats in that they are not intended to provide protection against contact with electrical conductors. Class C hard hats may include vented options which not only protect the wearer from impact, but also provide increased breathability through their conductive material (such as aluminum) or added ventilation.

In some embodiments, the hard hat or VFHCD further comprises one or more optional sensors 2114. The sensors are preferably located around the perimeter of the hard hat 2102 or at various locations in the frame of the HCD 2100. The VFHCD or hard hat further comprises compartments 2116 where the sensor electronics are located. In some embodiments, the sensor electronics may be located inside the hard hat or inside the frame 2108 of the VFHCD.

Various types of sensors may be used. One or more sensors can be configured to detect either an environmental condition or a condition of the user. A processor may be configured to receive signals from the one or more sensors and execute a protective measure.

Various types of sensors may be used. In a preferred embodiment, one or more proximity sensors are installed in the VFHCD/hard hat embodiment. The proximity sensors can warn a user if the user is coming into close proximity to a stationary object, or a large moveable object is approaching such as a forklift or autonomous robot and detect a possible collision. The sensors may also bs used to provide a warning or signal to the person operating the heavy machinery or other large object to halt or divert their movement. The proximity sensors may also detect if a user is approaching a particularly dangerous location and other scenarios. The sensors would alert the user to the danger. Different types of audible signals or visual messages may be relayed to the user depending on the type of danger present. The sensors may also be able to wirelessly relay the location information in real-time to a central database to be tracked, monitored, and recorded, such as by a site manager. If an incident does occur, the incident can be automatically tracked and recorded and relayed to and warn other users in the industrial setting of any dangers.

The VFHCD 2100 or hard hat 2102 may comprise a unique QR code. The QR code may be scanned by a scanner or cell phone which is relayed to a monitoring system that a user is entering the industrial setting. Each user may be assigned a unique QR code. Once a user places a VFHCD and hard hat on, the movements of the user can be tracked and warned of any impending danger. The VFHCD or hard hat may comprise a GPS device to track the movements of the user. The device may also be used to communicate with other users so that user can send to or receive alerts from other users.

In the event a user is at risk of being hit with an object, the proximity sensor may detect the object and an inflatable personal airbag may be deployed from the VFHCD 2100 or hard hat 2102 to minimize any danger to the head and neck area of the user.

Face shield 2106 may further comprise a layer of a polarizing film or an electrochromic layer, or a combination thereof, on the inner or outer surface as previously disclosed herein to filter EMR. One or more sensors may be configured to detect harmful light rays and the protective measure to block the harmful light rights from harming the user's eyes. In an exemplary embodiment, the EMR filtering layer can filter light with a wavelength range of about 200-380 nm. The film may sufficiently filter UV and infrared light so that the VFHCD can be safely used by welders in fusion and pressure welding processes. The film or shield may further comprise a protective layer to protect against flash burn or sparks that may occur during welding. In an exemplary embodiment, the face shield with the EMR filtering layer is American National Standards Institute (ANSI) Z87.1+ certified and compliant. The entire face shield or a portion of the face shield may be covered by an EMR film.

For further protection for welders, the filters in the VFHCD may be capable of filtering welding fumes or other toxic fumes or atmosphere. Welding fumes typically consists of visible smoke that contains harmful metal fume and gas byproducts. Welding fumes can contain a variety of metals, including aluminum, arsenic, beryllium, lead, and manganese. Argon, nitrogen, carbon dioxide, carbon monoxide, and hydrogen fluoride gases often are produced during welding. Sensors may be combined with the VFHCD to specifically detect welding byproducts. The sensors would preferably be placed inside the VFHCD near an inlet filter to detect any welding fume ingress. The sensors could give a visual or audible warning to the user. The sensors may also seal the VFHCD and provide stored safe air to the user from a canister located on the VFHCD or elsewhere on the user such as an air tank.

In some embodiments, the fabric component 2110 comprises a flame-retardant or flame-resistant textile. The fabric may be of the Marlan class of fabrics such as Marlan AL600 aluminized fabric, Marlan HV, or Marlan SX. The fabric may comprise aramid (e.g., Nomex), polybenzimidazole, melamine, coated nylon, flame-retardant cotton, carbon foam, or modacrylic.

One or more sensors may notify the user of harmful levels of noise. The noise reduction devices 2112 may be enhanced to limit the amount of occupational noise the user is exposed to in loud industrial environments and to protect the hearing ability of the user. For example, the noise reduction devices may be able to prevent the user from being exposed to noise greater than 85 decibels. The VFHCD comprises optional secondary electronic noise reduction devices 2118. The secondary electronic noise reduction devices are connected to a power source by one or more wires 2120. The electronic noise reduction devices comprise optional noise or wave cancelling earpieces adjacent to the ear canals to reduce occupational noise. A barrier may be moved over the ears of the user to block harmful sound and noise to prevent ear damage.

In some embodiments, one or more sensors are configured to detect a condition of the user selected from the group consisting of pulse rate, respiratory rate, body temperature, head orientation, closed eyes, and combinations thereof. If a condition reaches a harmful pre-determined level or conditions, an audible or visual alert may be sent to the user. Furthermore, an alert may be sent to or received from a coworker that is having a medical issue or event.

In some embodiments, the VFHCD may comprise lights 2122 for a user to see in dimly lit locations, such as in a mine or at night. The lights are able to illuminate in a forward or rearward direction. In some embodiments, the lights may further comprise a camera. The camera may face the front, the rear, or be a front and rear facing camera. The light may be connected to the frame and pass through a slit or hole in the fabric component 2110.

Smart App for Working with a Variable Flow Head Covering Device (VFHCD)

The following embodiments describes a variable flow head covering device (VFHCD) wherein the electronic functions can be controlled and monitored by a smart app on a smart device. The smart app may be compatible with smart devices, such as smart phones, tablets, and wearables. The smart app may also include natural language processing (NLP) capabilities to allow for hands-free device usage, greater accessibility for individuals with disabilities, convenience, and novelty. The smart app may have augmented reality capabilities. The smart app may include predictive analytics for a more personal and engaging experience based on past movements and activities. The smart app may utilize biometric data, GPS, or other sensory hardware to provide information about the user, their environment, and their location. The smart app can be downloaded onto a mobile device such as a wearable, tablet, laptop, or cell phone. The smart app can be downloaded onto a non-mobile device such as a desk top computer.

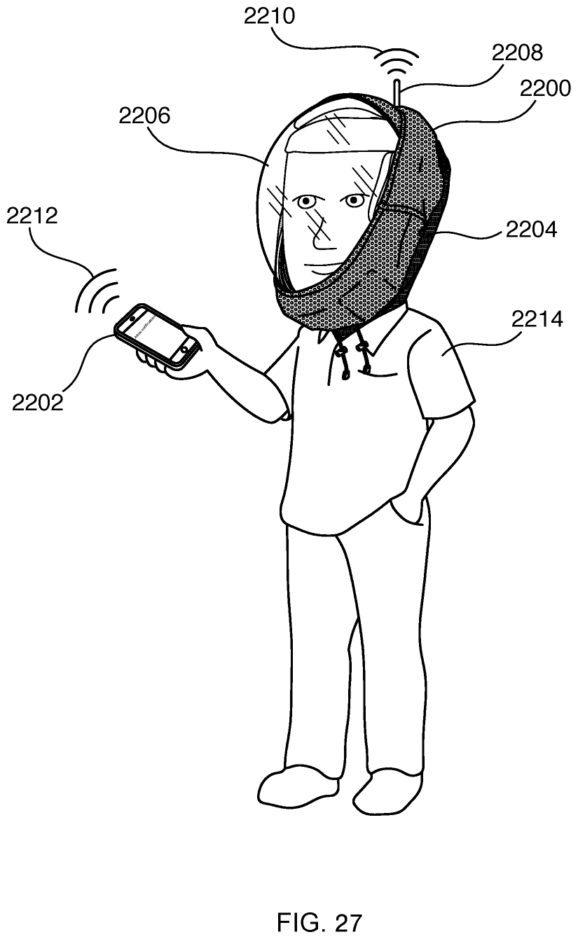

FIG. 27 is a view of user with a variable flow head covering device (VFHCD) 2200 that is controlled and monitored by an app on a smart device 2202, according to an embodiment of the disclosure. The VFHCD is similar to other HCD embodiments described herein comprising a flexible fabric component 2204, and rigid face shield component 2206. The VFHCD further comprises an antenna 2208 to receive a wireless signal that is extended from the top of the VFHCD. The extending antenna may be rigid or a flexible whip antenna. In other embodiments, the antenna may be hidden from view within the frame of the VFHCD or under the fabric component. In other embodiments the antenna may be in the form of wires located on the surface of the face shield.

The VFHCD comprises a controller that may include one or more communication systems, including Bluetooth communication chips, Internet Wi-Fi transceivers, network transceivers, a wireless mesh network device such as Z-Wave network transceiver, or a combination thereof to wirelessly communicate with a smart device. The controller may be mounted in the rigid component of the VFHCD. The controller is able to control various components of the VFHCD such as the rate of the air mover, humidity level, temperature, dimming of the face shield using an electrochromic layer, audio visual and communication components such as an image or video display, microphone, or speaker on demand by the user using an app on a smart device. The smart device may be a stand-alone smart device or integrated with the rigid component of the VFHCD. The one or more communication systems may communicate by a wireless signal 2210 with at least one of external remote controllers and a cloud-based network in real-time, intermittent time, or in pre-determined time intervals and lengths of time or a combination thereof.

The one or more communication systems may receive instructions from the external remote controller, generate signals 2212 instructing components of the VFHCD to operate and to monitor the status of various components. The communications system may generate a signal 2210 informing the external remote controller of the status of at least one device in the VFHCD. In an exemplary embodiment, the remote controller is a smart device such as a tablet, wearable, or mobile phone 2202 controlled by a user 2214.

The smart device communicates to a plurality of devices within the VFHCD. The smart device may also include a wireless transmitter and wireless transceiver and have a connection to each network device of the one or more devices. The connection may include a wired or wireless interface such as Bluetooth, WIFI, mesh network or similar wireless protocol.

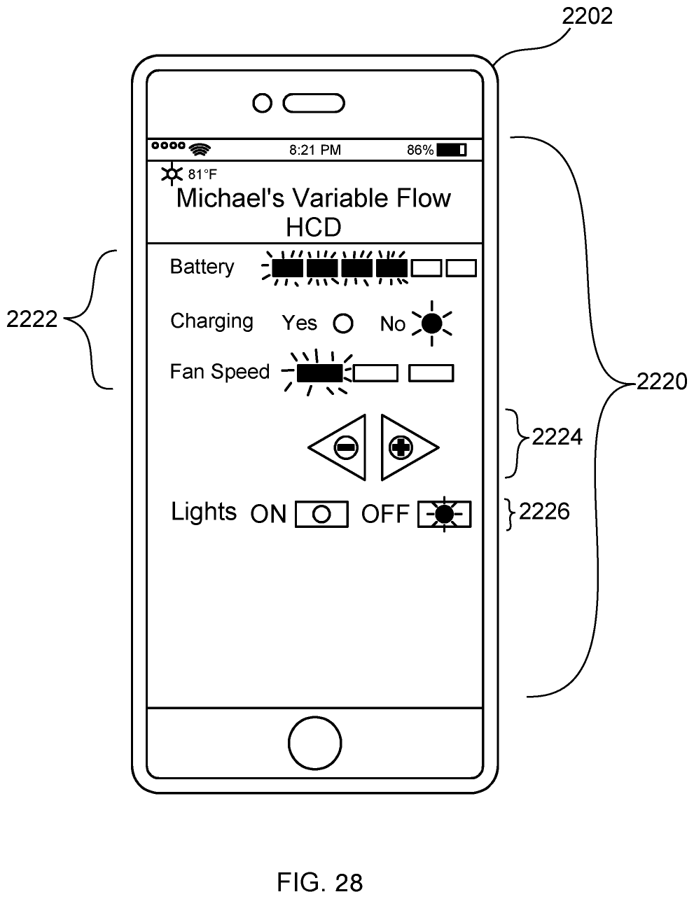

FIGS. 28 through 30 show various exemplary graphical user interface (GUI) pages associated with an application configured to execute on a mobile device. Nevertheless, in other embodiments, the application may be configured to execute on a desktop computer, workstation, tablet, laptop, or other suitable computing device.

FIG. 28 shows a graphical user interface 2220 for monitoring and controlling functions of a variable flow head covering device (VFHCD) with an app, according to an embodiment of the disclosure. The GUI example embodiment 2220 displayed on a mobile phone 2202 displays various information and multiple indicators and control functions. The name “Michael's Head Covering Device” as displayed at the top of the screen along with standard information such as the time, temperature, weather conditions, and battery charge status of the smart device. Although the name “Michael's Head Covering Device” is used for the name of the VFHCD for illustrative purposes, the user 2214 can give the device any name. In this embodiment, the battery charge status, whether the VFHCD is plugged in a charging, and the variable fan speed indicators 2222 are displayed. The app may provide an audible alert or a visual alert for the user on the GUI if the battery level goes below a certain level where a limited amount of usage time is left. Controls for the fan speed 2224 are also shown wherein touching “−” decreases the fan speed and pressing “+” increases the fan speed. Towards the bottom of the GUI is a control function where a user can touch “ON” or “OFF” 2226 to turn the lights on in a VFHCD. The lights may be lights inside or outside of the VFHCD.

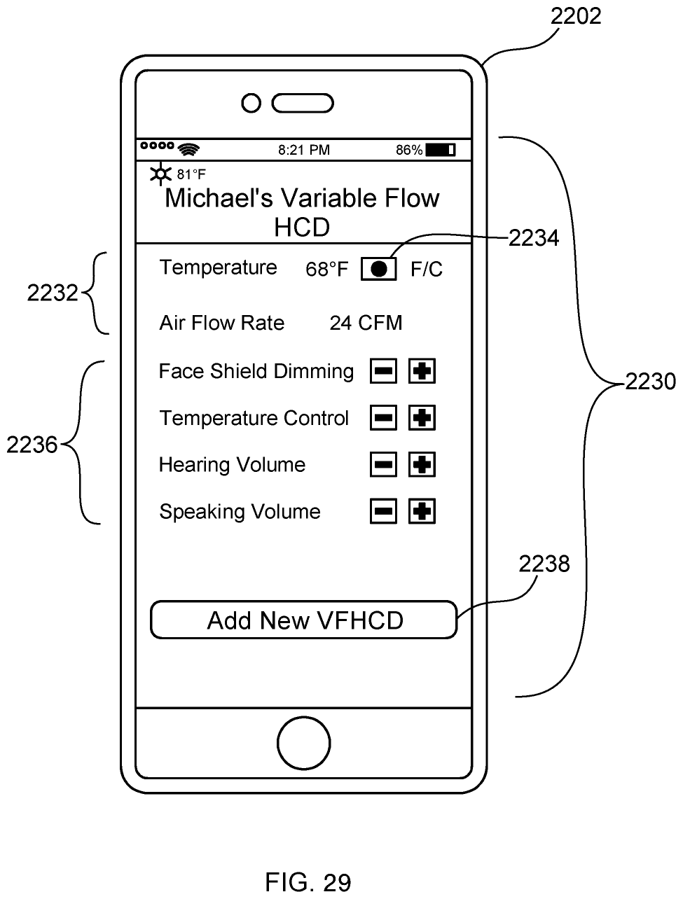

FIG. 29 shows a graphical user interface 2230 for monitoring and controlling functions of a variable flow head covering device (VFHCD), according to an embodiment of the disclosure. In this GUI embodiment 2230, the temperature and air flow rate 2232 inside the device are displayed. The temperature can be switched by touching an icon 2234 on the screen to toggle between ° F. and ° C. depending on what is desired by a user. Other functions 2236 may be controlled such as activating an electrochromic layer to dim the face shield, control the internal temperature of the HCD, turn up the hearing volume for the user to hear others, or turn up the speaking volume for others to better hear the user of an HCD. Electromagnetic radiation sensors may be used to determine if the electrochromic layer needs to be activated to limit amount of light entering the face shield and provide shade (i.e., shade function) to the user or by a command from the user.

In some embodiments, the mobile device app may be able to monitor and control more than one HCD. At the bottom of GUI embodiment 2230, a user can touch “Add New Device” 2238 to add another VFHCD. The VFHCD could be added by a QR code located on the VFHCD or search by the name of the VFHCD. A Bluetooth verification method could be used to create a connection between the mobile phone device and the VFHCD. A QR code located on a VFHCD could also be scanned to link the VFHCD to the mobile phone app.

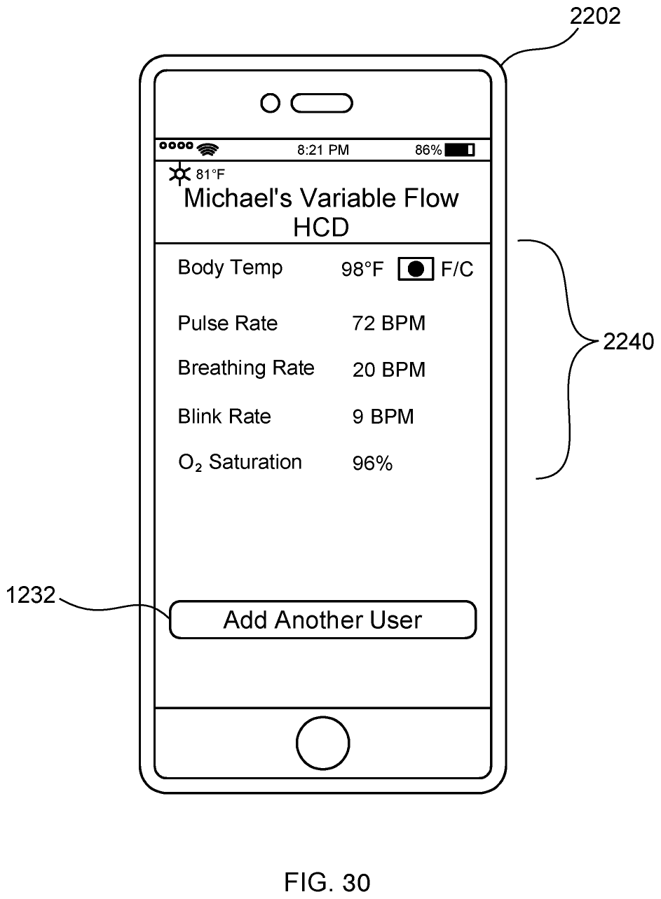

FIG. 30 shows a graphical user interface 2240 for monitoring biometric information in a variable flow head covering device (VFHCD), according to an embodiment of the disclosure. In this example, various biometric data are displayed 2240 such as body temp, pulse rate (beats per minute (BPM)), breathing rate (breaths per minute (BPM)), blink rate (blinks per minute (BPM)), and oxygen saturation levels (% O₂) that are collected by various sensors in the VFHCD. Other biometric data may be displayed such as head orientation, closed eyes, and combinations thereof. The app may be able to store and monitor the biometric data for more than one user. This can be achieved by touching “Add Another User” 2242 shown at the bottom of the GUI. The biometric data can be selectively collected on a user if the designated user is confirmed by a fingerprint or retinal scanner. A VFHCD may further comprise a processor for receiving signals from biometric sensors and communicate biometric information to the smart device, and wherein the app is configured to receive and process biometric information and provide reports to the user.

The app may provide alerts for any information collected by the VFHCD such as performance of the VFHCD itself or biometric data collected on the user. The alerts may be programmed and set by the user or may be set based on the age, weight, height, or other information of the user.

The app may provide alerts for information collected by safety sensors in occupational safety applications such as exterior temperature, noise level, or air quality. The app may be configured to control the temperature, air flow, volume inside of the HCD based on the ambient noise levels in occupational and non-occupational settings. Air pressure differences may also be monitored by one or more sensors and relayed to the smart device and displayed by the app.

The app may receive signals from one or more sensors to test and/or monitor fitment of the system such as the detection of leaks around the seal of the flexible fabric component and the neck area of the user. The sensors may be able to detect a gas for use in testing fitment.

In some embodiments, the app may provide audio assistance to users who are blind and cannot read the GUI. The audio assistance would read what is one the GUI to the user. The volume of the audio could be controlled for the hearing impaired. The app may be used to control video images or projections within the VFHCD.

The app may be configured to provide an intercom system with one or more users using a similar HCD system.

The app may be configured to provide filter end of useful life alerts to the user based on at least one of age of the filter, increased head pressure on the filter and optical readings indicating a dirty filter.

### Active Band for a Variable Flow Head Covering Device (VFHCD)

The following embodiments describes a device to more secure a variable flow head covering device (VFHCD) to the head of a user.

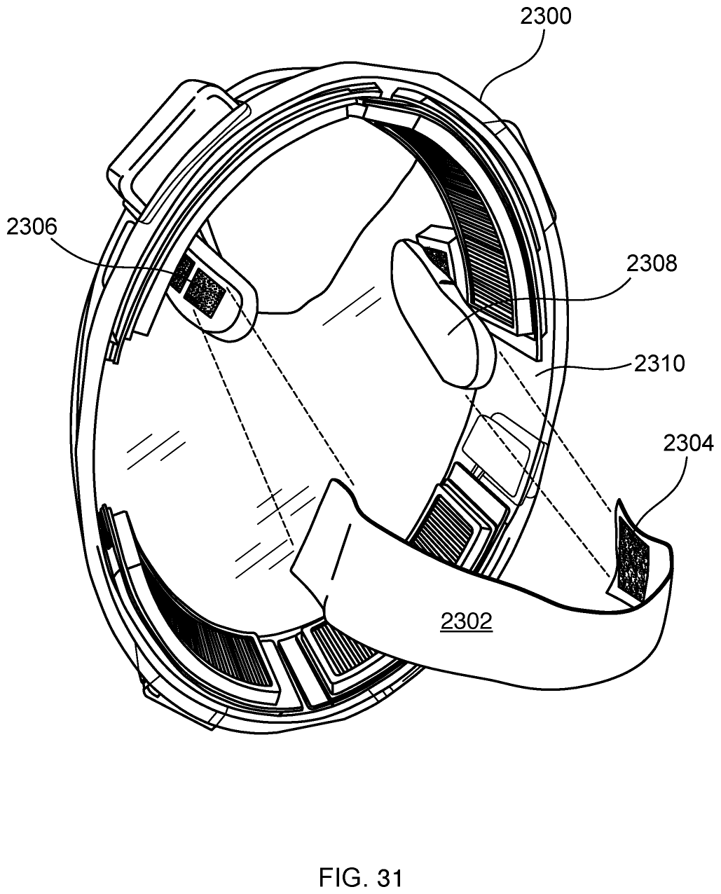

FIG. 31 illustrates how an active band 2302 is to be installed in a variable flow head covering device (VFHCD) 2300, according to an embodiment of the disclosure. The fabric component portion of the VFHCD in FIG. 31 has been removed to better view how the active band is installed. An active band 2302 is a stretchable elastic band that connects to one side of a VFHCD, goes behind the head of the user inside of the fabric component, and connects to the other side of the VFHCD to better secure the device to the head of a user. The band helps to prevent slippage of the device when used by an active user by applying pressure of the mask to the face of the user. This allows a user to wear the device while playing sports (e.g., skiing, cycling), riding in a convertible vehicle, operating construction equipment, or active manual labor.

One end of the active band with an attaching device is connected to one side of the VFHCD, while the other end is connected to the other side of the VFHCD. In the embodiment in FIG. 31, the attaching device near each end of the active band is a hook and loop fastener (e.g., Velcro) 2304 though other attaching devices may also be suitable such as snaps or screws. The receiving portion of hook and loop fastener 2306 on the HCD is located on the outward facing surface of the earpiece 2308. The other end of the earpiece is affixed to the frame 2310. The dotted lines illustrate where the active band is connected to the earpieces.

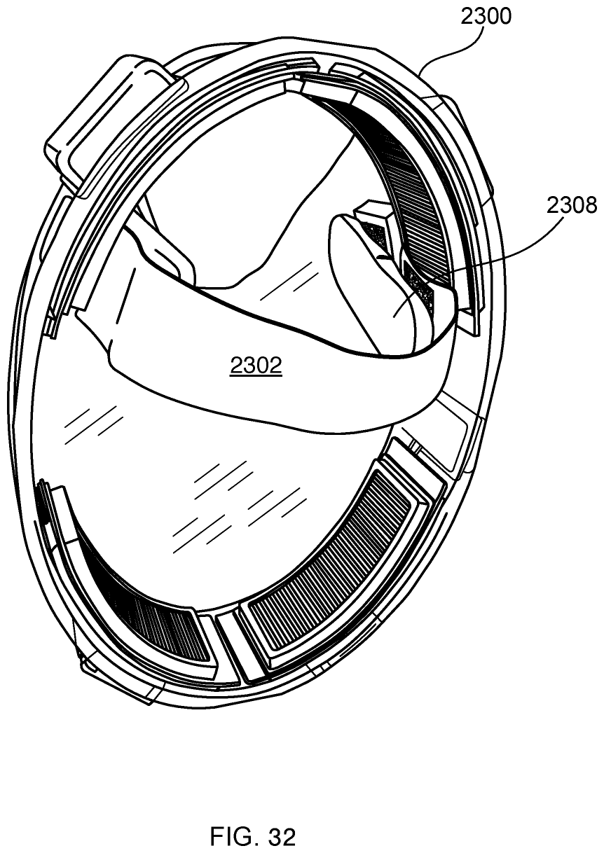

FIG. 32 is a view of a variable flow head covering device (VFHCD) with an active band installed, according to an embodiment of the disclosure. In this view, the active band 2302 is affixed and connected to the earpieces on the VFHCD 2300. The fabric component would then be installed over the frame and active band. The user's head would go inside of the active band such that the band applies slight pressure to the back of the user's head to firmly press the VFHCD to the face of the user.

### Vibration Isolating and Noise Dampening Air Moving Device

The following embodiments describes an air moving device that is design to minimize and isolate vibrations and dampen noise caused by an air mover in a personal air filtration device.

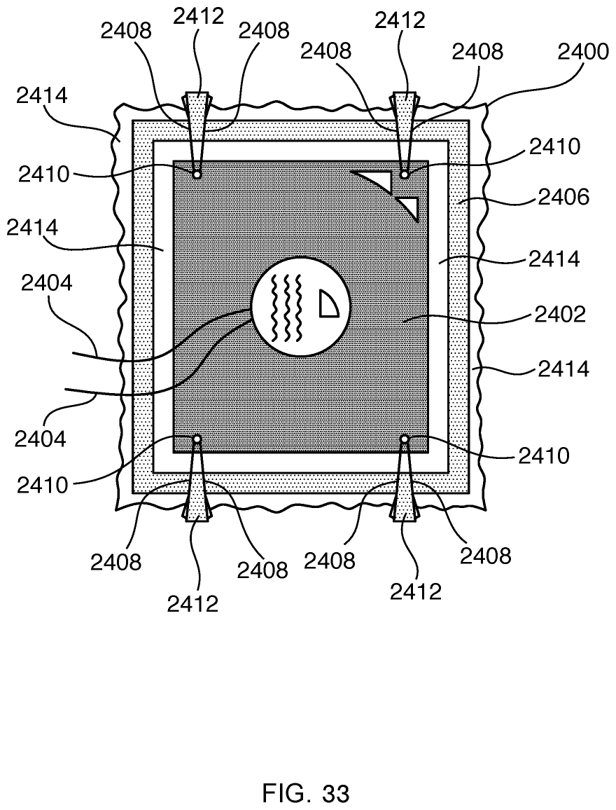

FIG. 33 is a front view of a vibration isolating air moving device (VIAMD) 2400, according to an embodiment of the disclosure. The VIAMD comprises an air mover assembly 2402. An air mover assembly may also be referred to as a fan assembly and may be used interchangeably herein. The air mover assembly comprises an impeller 2416 contained within and supported by a housing. The fan assembly may be powered by a battery or solar cell. The battery may be a rechargeable battery. Wires 2404 from the power source are used to supply a current to operate the fan. The fan may be a multi-speed or variable speed fan that can be adjusted to a lower speed, when appropriate, to further reduce the noise from one or more air mover assemblies within an HCD. One of the fans first and second air mover assemblies can be turned off, when appropriate to further reduce the noise within the device.

The VIAMD further comprises a top fan frame 2406. The top fan frame is larger than the fan assembly 2402 and surrounds the periphery of the fan. There is a gap between the fan and the top fan frame. The gap is preferably large enough so that when the fan is in operation, the fan does not come into contact with the top fan frame such as from vibrations. The fan frame is comprised of a rigid material such as a polymer. The fan assembly frame may be rectangular, square-like, or any shape or size to be able conform to a device to provide air flow. The top frame may act as a mounting frame to mount the fan assembly to an HCD.

The VIAMD further comprises pliable or elastic members 2408 to connect the fan to the top fan frame. The members may be bands that may further be made of rubber, or other elastomer such as butyl rubber, natural or synthetic isoprene, chloroprene, nitrile rubber, or styrene-butadiene rubber. The bands hold the fan assembly in place within the front side of the top fan frame in a suspended manner. The bands are connected to the fan assembly by receiving holes 2410 located near each corner of the fan. In an exemplary embodiment, the housing has a rectangular periphery and wherein an elastic band is attached at each of the housing's four corners. The elastic bands can be thread through the holes and tied to the fan assembly. The other end of the elastic bands are connected to the top fan frame by wrapping around a frame receiving post or member 2412. Each elastic band is attached at one end to a different corner of the housing of an air assembly and is attached at another end to a different point on the rigid component of a fan frame or rigid component of the HCD. The receiving frame members protrude from an outer edge of the top fan frame. Other means may be used to connect the elastic bands to the fan and frame receiving members. In other embodiments, any combination of two or more posts may be used to connect the elastic bands to. The elastic bands can absorb vibrations during operation of the fan assembly and reduce the amount of vibrations transmitted to the rigid component of an HCD.

The VIAMD further comprises a flexible membrane 2414. The membrane comprises a silicone-based material but could be another polymeric material. The membrane can further absorb vibrations and help to dampen the sound coming from the fan. The membrane is located on the opposite side of the top fan frame 2406 from the elastic bands. The membrane spans from the top to the bottom of the top fan frame and from one side to the other side of the top fan frame. The membrane is slightly wider and longer than the frame though the membrane may be approximately the same width and length of the frame. The membrane helps to reduce air flow through the air gap. The membrane comprises an aperture to allow for air to pass through that is moved by the fan.

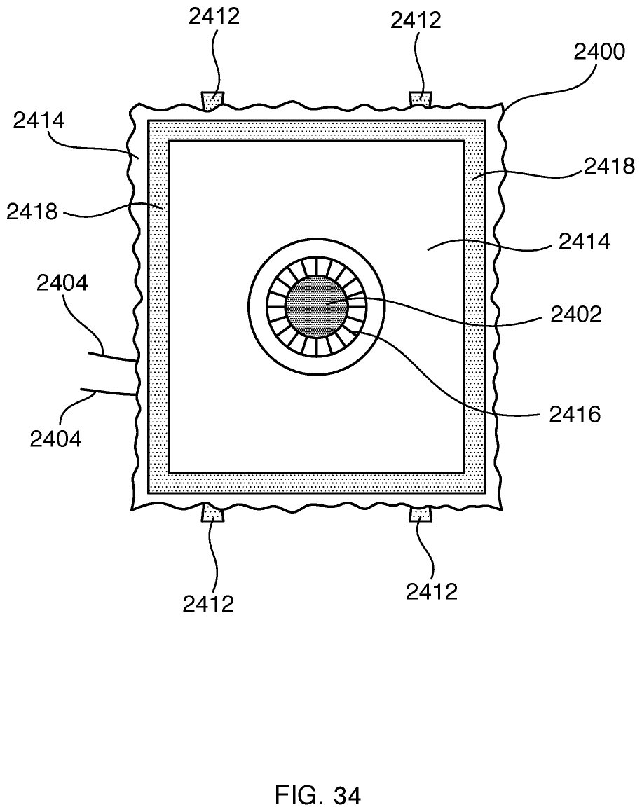

FIG. 34 is a rear view of a vibration isolating air moving device (VIAMD) 2400, according to an embodiment of the disclosure. In this view the rear view of the fan 2402 can be seen along with the fan impeller 2416. Also illustrated in the is view is a bottom fan frame 2418. The bottom fan frame is substantially the same width and length as the top fan frame 2406. The membrane 2414 is pinched or sandwiched in between the top and bottom frames to keep it in place. The bottom fan frame is made of a rigid polymer. In some embodiments, the bottom fan frame may be a spongy material that conforms to the device it is attached to and may further act as a resilient mount. The protruding posts 2412 from the top frame can also be seen. The bottom fan frame may act as a mounting frame to mount the air assembly to a rigid component in an HCD.

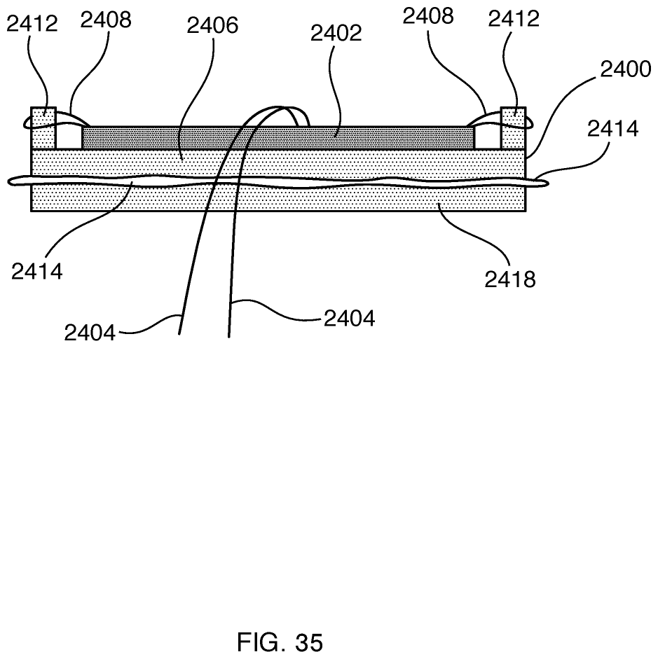

FIG. 35 is a side view of a vibration isolating air moving device (VIAMD) 2400, according to an embodiment of the disclosure. This view further illustrates the multi-component structure of the VIAMD. The bottom structure in FIG. 35 is the bottom fan frame 2418 wherein the membrane 2414 is located on the top side and secured in place by top fan frame 2406. The top and bottom fan frames are secured together by screws, clamps, or other securing mechanism. The fan assembly 2402 is located on the top side of the membrane and joined to the top fan frame by elastic bands 2408.

In some embodiments, a bottom fan frame is not used wherein the top fan frame is directly connect to a device to supply air flow from the fan. The membrane acts to form an airtight seal between the fan frame and device requiring air flow. In some embodiments, the bottom fan fame is a soft or sponge-like material to form an airtight seal to the device it is attached to. In other embodiments, a very high bonding or adhesive tape may be used to form a seal between the bottom fan frame 2418 and the device to which hit is attached to. The tape may also act as a resilient mount to further dampen and isolate vibrations.

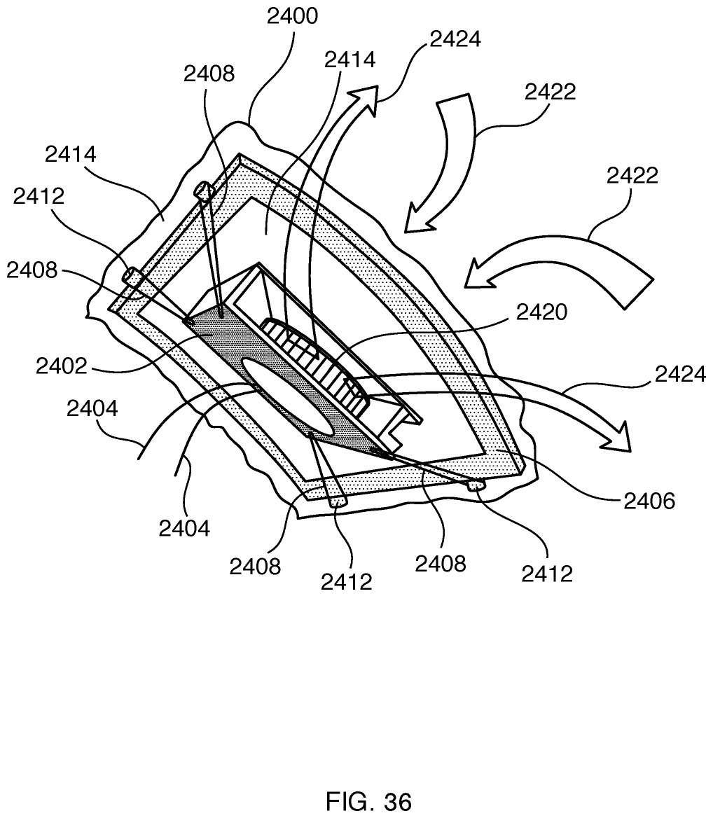

FIG. 36 is a side view of a vibration isolating air moving device (VIAMD) 2400 showing the fan outlet and air flow, according to an embodiment of the disclosure. In this view the fan 2402 has been slightly titled to better view the exhaust air outlet 2420. When in operation, the fan pulls in intake air 2422 on the opposite side as shown in FIG. 34. The exhaust air 2424 is exhausted out the exhaust air outlet on one side of the fan. During operation, the vibrations of the fan are dissipated by the elastic bands 2408. This limits vibrations from propagating into the structure to which the VIAMD is attached to.

The vibration isolating air moving device (VIAMD) 2400 or related embodiments may be used in any of the head covering devices (HCDs) disclosed herein. The VIAMD would be directly attached to the rigid frame component to pull in or push out air through an intake or exhaust port and through an intake or exhaust filter. In some embodiments, the air mover assembly would be mounted on the rigid component of an HCD described herein without the need for a fan frame by vibration absorbing members, to thereby reduce transmission of the vibration of the air mover assembly to the rigid member, thereby reducing noise from the air mover assembly within the device. The HCD may comprise receiving members to attach one end of the elastic bands to and the other end of the elastic bands to an air mover assembly. The rigid fan assembly frame component further comprises a mounting frame surrounding either the inlet port or the outlet port in an HCD, and wherein the mounting frame comprises mounting features for receiving the other ends of the elastic bands.

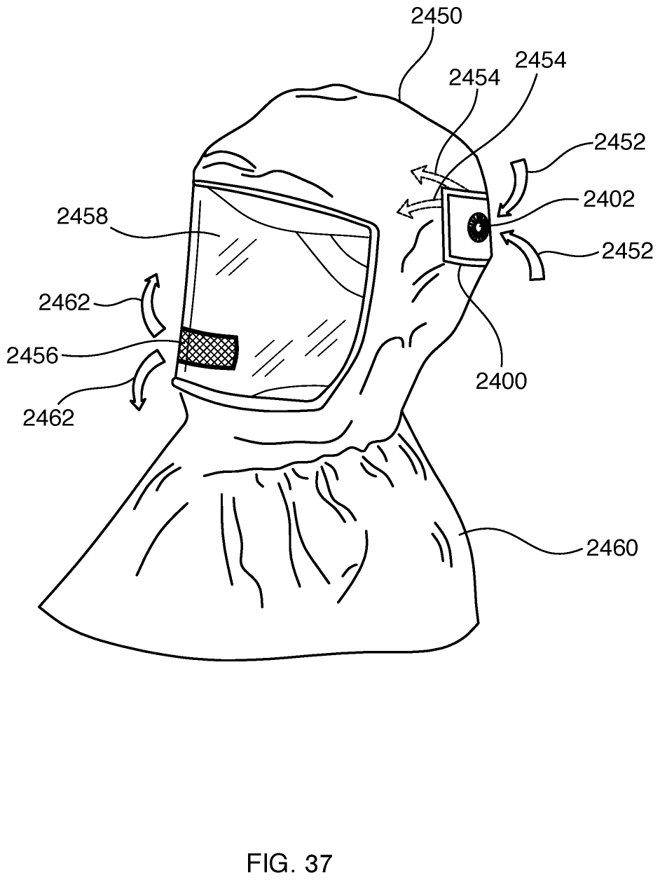

The VIAMD may be used in other types of air control devices such as masks for powered air purifying respirators (PAPRs). FIG. 37 is an example of combining a PAPR mask 2450 with a vibration isolating air moving device (VIAMD) 2400, according to an embodiment of the disclosure. The PAPR mask illustrated is a commonly used PAPR mask. Any PAPR mask may be used an integrated with a VIAMD. The VIAMD is mounted to the rear of the mask but could be located elsewhere. Intake air 2452 is pulled into the mask by the fan assembly 2402. The intake air enters the mask where it may be filtered beforehand. For example, a filter may be placed over the fan on the outside of the PAPR mask or on the inside as filtered intake air 2454.

The PAPR mask may further comprise an outlet filter 2456. The outlet filter in this embodiment is located in the transparent shield component 2458 near where the mouth of a user is located. The filter may be located elsewhere such as in the cloth component 2460 of the mask. Air leaving the mask is filtered exhaust air 2462. This design is an improvement over commonly used PAPRs where a fan is located on the belt of a user and connect by a hose to the rear of the mask. These types of masks filter the air going into the mask but not the air that is exhausted from the mask. The embodiment described herein not only protects the wearer of the PAPR mask but also protects a patient being cared for by the wearer in the instance where the wearer may be infected with a contagious disease.

The invention has been described with reference to various specific and preferred embodiments and techniques. Nevertheless, it is understood that many variations and modifications may be made while remaining within the spirit and scope of the invention.

What is claimed is:

1. A device for filtering air for a user comprising:
a rigid component comprising:
a transparent face shield that provides a space for air between an inside surface of the face shield and the user's face;
an intake port, through which air enters the device;
an exhaust port, through which air exits the device;
a fabric component affixed to the rigid component that, combined with the rigid component, covers the user's head and seals around the user's neck;
an intake filter that filters air passing through the intake port;
an exhaust filter that filters air passing through the exhaust port; and
an air mover held by the rigid component that moves air through the intake port and out the exhaust port.

2. The device of claim 1, wherein the rigid component further comprises an oval-shaped frame to which the transparent face shield is attached.

3. The device of claim 2, wherein the fabric component is releasably attached by stretching around the frame.

4. The device of claim 3, wherein the fabric component comprises an elastic band to facilitate stretching around the frame.

5. The device of claim 1, wherein the fabric component further comprises a drawstring to facilitate forming a seal around the user's neck.

6. The device of claim 1, wherein a portion of the fabric component comprises that does not cover the rigid frame is substantially impermeable to air.

7. The device of claim 6, wherein another portion of the fabric component covers the air mover, and wherein the other portion of the fabric component is permeable to air.

8. The device of claim 1, wherein the fabric component has sufficient elasticity to allow a user to push against and outer surface of the fabric component to scratch or dab his face without breaking the seal around the neck.

9. The device of claim 2, wherein the air mover is a fan assembly attached to the frame.

10. The device of claim 9, wherein the fan is attached with a vibration absorbing mount to reduce noise and vibration in the device.

11. The device of claim 10, wherein the air mover is powered by a rechargeable battery attached to an upper portion of the frame.

12. The device of claim 1, wherein the face shield is in the shape of a hemi-ellipsoid.

13. The device of claim 1, wherein the air mover pulls intake air from outside of the device through the intake filter and into the device, whereby exhaust air is pushed through the exhaust filter to outside of the device.

14. The device of claim 1, wherein the air mover pulls air from inside the device through the exhaust filter to outside of the device, whereby intake airs is pulled from outside of the device through the intake filter and into the device.

15. A device for filtering air for a user comprising:
a rigid component comprising:
an oval-shaped frame
a transparent face shield that provides a space for air between an inside surface of the face shield and the user's face;
a first and a second intake port, through which air enters the device;
a first and a second exhaust port, through which air exits the device;
a fabric component affixed to the rigid component that, combined with the rigid component, covers the user's head and seals around the user's neck;
first and second intake filters that filter air passing through the intake ports;
first and second exhaust filters that filter air passing through the exhaust ports; and
a first and second air mover disposed over either the first and second intake ports, respectively, or the first and second exhaust ports, respectively, whereby filtered air is moved into the device through the intake ports and moved out of the device through the exhaust ports.

16. The device of claim 15, wherein the first and second intake filters and the first and second exhaust filters are provided in filter cartridges.

17. The device of claim 16, wherein the filter cartridges are releasably attached to an inner surface of the frame, to thereby facilitate replacement of the filter cartridges.

18. The device of claim 16, wherein the first intake port is adjacent the first exhaust port, where the second intake port is adjacent the second exhaust port, wherein the first intake filter is combined in a single cartridge with the first exhaust filter, and wherein the second intake filter is combined in a single cartridge with the second exhaust filter.

19. The device of claim 15, wherein the combined surface areas of the intake and exhaust filters is greater than 200 inch².

20. The device of claim 1, further comprising an elastic band that connects to one side of the device, goes behind the head of the user inside of the fabric component, and connects to the other side of the device to better secure the device to the head of the user.
